(19) United States
(12) Patent Application Publication
(10) Pub. No.: US 2024/0318757 A1
(43) Pub. Date: Sep. 26, 2024

(54) FLUID COMMUNICATING STRUCTURE

(71) Applicant: FIVEGRAND INTERNATIONAL CO., LTD., New Taipei City (TW)

(72) Inventor: Ting-Jui WANG, New Taipei City (TW)

(21) Appl. No.: 18/427,842

(22) Filed: Jan. 31, 2024

(30) Foreign Application Priority Data
Mar. 24, 2023 (TW) 112111261
Jul. 17, 2023 (TW) 112126503

(51) Int. Cl. F16L 37/46; F16L 37/40

(52) U.S. Cl. CPC F16L 37/46; F16L 37/40

(57) ABSTRACT

A fluid communicating structure includes at least one body and at least one block unit, and a communicating method thereof. The body includes a flow channel. The block unit is movably combined with the body, and is configured to open or close the flow channel. Thus, a required fluid is enabled to flow stably with flow guidance of the body.

### CROSS-REFERENCE TO RELATED APPLICATION

This non-provisional application claims priority under 35 U.S.C. § 119(a) on Patent Application No(s). 112111261 filed in Taiwan, R.O.C. on Mar. 24, 2023 and Patent Application No(s). 112126503 filed in Taiwan, R.O.C. on Jul. 17, 2023, the entire contents of which are hereby incorporated by reference.

### BACKGROUND OF THE INVENTION

### 1. Field of the Invention

The present disclosure provides a fluid communicating structure and a communicating method thereof, and in particular to a fluid communicating structure and a communicating method thereof enabling a required fluid to flow stably.

### 2. Description of the Related Art

In common fluid transportation, a valve is provided according to a pipeline of the fluid to serve as a switch for the fluid transportation.

However, a gap is usually caused in such conventional valve after use for an extended period of time, resulting in loss of the function of the valve and hence failure of stable transportation of the fluid in the pipeline.

### BRIEF SUMMARY OF THE INVENTION

In view of the prior art above, the applicant has developed a fluid communicating structure and a communicating method thereof in the aim of achieving an object of enabling a required fluid to flow stably with flow guidance of a body.

To achieve the above and other objects, the present disclosure provides a fluid communicating structure including at least one body and at least one block unit. The body includes a flow channel. The block unit is movably combined with the body, and is configured to open or close the flow channel.

In the fluid communicating structure above, the body and the block unit are provided with a first elastic element in between. The first elastic element locates the block unit to be at an open position of the flow channel, or the first elastic element locates the block unit to be at a closed position of the flow channel.

In the fluid communicating structure above, the block unit is provided with an operation portion which operates the block unit to operate.

In the fluid communicating structure above, the operation portion is movably assembled with the block unit, the operation portion and the body have a first height and a second height in between, and the block unit is operated at the first height or the second height by the operation portion.

In the fluid communicating structure above, the body is provided with at least one fastener. The fastener serves as engagement between two bodies, or serves as engaged between the body and an object.

In the fluid communicating structure above, the fastener and the body are provided with a second elastic element in between. The second elastic element exerts an elastic force to pull tight the two bodies, or the second elastic element exerts an elastic force to pull tight the body and the object.

In the fluid communicating structure above, the fastener is a thread, a column, an outer fastener, an elastic fastener, an inner fastener, a sphere or a bead.

In the fluid communicating structure above, the fastener is an outer fastener and is inserted into one of the bodies and rotated, so that the fastener is fitted into a body limiting portion of the body.

In the fluid communicating structure above, the fastener is provided with a stop portion. The stop portion and the body stop against each other, or the stop portion and a body limiting portion of the body stop against each other, so that the stop portion limits an engagement position of the fastener.

In the fluid communicating structure above, the body limiting portion is a two-layered limiting structure so as to limit positions of the stop portion and the fastener.

In the fluid communicating structure above, the block unit can be parallel to the body, or the block unit can protrude from the body, or the block unit can be recessed into the body, or the block unit can be elastically parallel to the body, or the block unit can elastically protrude from the body, or the block unit can be elastically recessed into the body.

In the fluid communicating structure above, the block unit is two in number, each of the block units is provided with a first elastic element, and the first elastic elements locate the block units to be at closed positions of the flow channels, or the first elastic elements respectively pressurize the block units to elastically push against each other and be located at the closed positions of the flow channels, or the first elastic element locates the block unit to be at the closed position of the flow channel.

In the fluid communicating structure above, the body is provided with a body limiting portion, and the block unit coordinates with the body limiting portion and is limited at the open position of the flow channel or is limited at the closed position of the flow channel.

In the fluid communicating structure above, a position at which the flow channel enters the body or a position at which the flow channel is combined with the block unit is at a different height or a different angle, or the block unit and the flow channel are located at different angles or in different directions, or the block unit and the flow channel form an angle of 90 degrees, or the block unit and the flow channel form an angle between 170 degrees and 10 degrees.

In the fluid communicating structure above, the body or the block unit is provided with at least one fluid block unit, or the fluid block unit can be a ring unit, an elastic unit, a rubber unit, a silicon unit, a fluid absorbing unit or a bulk unit, or the fluid block unit can be disposed at any position through which a fluid passes, or the fluid block unit can be disposed at any motion position of the block unit or the body.

In the fluid communicating structure above, the fluid block unit is a ring unit.

In the fluid communicating structure above, the fluid is a liquid, a gas, oil, water, a liquid coolant, a water coolant or a chemical substance.

In the fluid communicating structure above, the body is provided with at least one fastener, the body and the fastener are provided with a second elastic element in between, the second elastic element is a torsion spring, and two ends of the second elastic element are respectively fixed at the body and the fastener, so that the fastener operates in coordination with the second elastic element.

In the fluid communicating structure above, the flow channel includes an inlet flow channel, an outlet flow channel, a connecting flow channel and a sealing unit. The connecting flow channel communicates the inlet flow channel and the outlet flow channel, the sealing unit is disposed at the body, and the sealing unit seals the connecting flow channel and one side of the body.

In the fluid communicating structure above, the body is machined, milled, molded, de-waxed, split-edge locked, split-edge bonded, split-edge fastened or split-edge welding combined.

The fluid communicating structure above includes two block units which elastically push each other, so that the block units open or close the flow channel.

In the fluid communicating structure above, the body is two in number, each of the bodies includes an alignment connecting portion, and the bodies are alignment connected, aligned with or prevented from rotation relative each other by using the alignment connecting portions, or the block unit is two in number, each of the block units is provided with a corresponding coupling portion, and the block units are alignment connected, limited, prevented from rotation, stabilized, aligned or engaged by using the corresponding coupling portions, or the block unit is provided with a guide angle, an angle or an arc to readily be guided into one of the bodies, or be guided into another body, or be guided into an object.

In the fluid communicating structure above, the elastic element normally pushes against the block unit and the body, so that the block unit is located at a position for stopping the flow channel.

In the fluid communicating structure above, the block unit is provided with a resist portion, and the resist portion and the body resist each other, or the resist portion is a structure that guides a fluid.

In the fluid communicating structure above, the resist portion is a structure that guides a fluid.

In the fluid communicating structure above, the body is provided with a fastener, which limits the block unit to locate at a position at which the flow channel is open or a position at which the flow channel is closed.

In the fluid communicating structure above, the block unit is provided with a fastener, which limits the block unit to locate at a position at which the flow channel is open or a position at which the flow channel is closed.

In the fluid communicating structure above, the fastener is a column, a fastener, a thread, an elastic fastener, an inner fastener or an outer fastener.

In the fluid communicating structure above, the block unit and the flow channel are located at different angles or in different directions.

In the fluid communicating structure above, the block unit is provided with at least one block unit limiting portion, which is engaged with a fastener so as to limit the block unit to locate at a position at which the flow channel is open or a position at which the flow channel is closed.

In the fluid communicating structure above, the body is two in number, and each of the bodies includes a fastener or a fastening portion, and the bodies or the fastening portions are engaged with each other by fasteners.

In the fluid communicating structure above, the fastener or the fastening portion of one of the bodies is engaged with the fastener or the fastening portion of the other body by means of pressing of a second elastic element.

In the fluid communicating structure above, at least one of the bodies is provided with a safety mechanism structure, and the safety mechanism structure and the block unit limit or block each other to limit the two bodies or to open the flow channel, or the safety mechanism structure and the block unit are departed or opened from each other to separate the two bodies or close the flow channel or to limit one of the bodies or open the flow channel, or at least one of the block units is provided with a safety mechanism structure, and the safety mechanism structure and the body limit or block each other to limit the two bodies or open the flow channel, or the safety mechanism structure and the body depart from or open each other to separate the two bodies or close the flow channel or to limit one of the bodies and open the flow channel.

In the fluid communicating structure above, at least one of the fasteners is provided with a motion distance, and the safety mechanism structure limits the block unit or the body, so that the block unit or the body limits a position of the fastener at the motion distance.

In the fluid communicating structure above, the safety mechanism structure departs from the block unit or the body, so that the block unit closes the flow channel and moves the fastener in the motion distance to separate the two bodies.

In the fluid communicating structure above, the block unit or the body is provided with a stop portion which is for stopping the fastener.

In the fluid communicating structure above, the fastener or the fastening portion of one of the bodies includes a limiting portion, and the fastener or the fastening portion of the other body is engaged at the limiting portion.

In the fluid communicating structure above, each of the fasteners or the fastening portions is a limiting portion, a groove, a recess, a track, a protrusion or a hole, has a neck, has a head, is a column, or is a structure with an inverted hook.

In the fluid communicating structure above, the block unit or the body is provided with an anti-rotation portion, and the anti-rotation portion prevents rotation of the body or the block unit, or the anti-rotation portion prevents rotation of the fastener, or the anti-rotation portion prevents rotation of an object.

In the fluid communicating structure above, the anti-rotation portion is a structure abutting against the fastener, or the anti-rotation structure is a stepped structure abutting against the fastener, or the anti-rotation portion is an elastic structure abutting against the fastener, or the anti-rotation portion is a structure that moves the fastener to fit into a limiting portion, or the anti-rotation portion is a structure that moves the block unit and then fits into a limiting portion, or the anti-rotation portion is a structure that moves the block unit and then automatically elastically fits into a limiting portion.

In the fluid communicating structure above, the body is two in number, and the flow channels of the bodies are located in different directions or the flow channels of the bodies are located at different angles.

The fluid communicating structure above is applied to data centers, cabinets, servers, memories, heat sinks, CPUs, GPUs, PCBs, ICs, connectors, industrial purposes or household purposes.

In the fluid communicating structure above, the body is two in number, and the flow channels of the bodies are located in different directions, or the flow channels of the bodies are located at different angles, or motion directions of the block units and the flow channels correspondingly blocked are located in different directions, or motion directions of the block units and the flow channels correspondingly blocked are located at different angles.

In the fluid communicating structure above, the block unit and the flow channel are located at different angles or in different directions, or the block unit and the flow channel form an angle of 90 degrees, or the block unit and the flow channel form an angle between 90 degrees and 30 degrees.

In the fluid communicating structure above, the body is two in number, or the body is two in number and each of the bodies has a block unit, or the body is two in number and one of the bodies has a block unit.

In the fluid communicating structure above, the block unit is two in number, each of the block units is provided with a corresponding coupling portion, and the block units are alignment connected, limited, prevented from rotation, stabilized, aligned or engaged by using the corresponding coupling portions.

In the fluid communicating structure above, the block unit is provided with a guide angle, an angle or an arc to readily be guided into one of the bodies, or be guided into another body, or be guided into an object.

In the fluid communicating structure above, the body is a combination of at least two elements, and the bodies combined to each other by the at least two elements resist, limit or press at least one fluid block unit.

In the fluid communicating structure above, the block unit is a combination of at least two elements.

In the fluid communicating structure above, the body is two in number, and the block unit of one of the bodies operates by at least one operation portion to open or close the flow channel.

In the fluid communicating structure above, one of the bodies is provided at an object, the object is provided with a heat generating unit and a heat dissipating unit, and a fluid in the flow channel flows through the heat dissipating unit so as to cool the heat generating unit.

In the fluid communicating structure above, the object is a server, a memory, a cabinet, a liquid cooling apparatus, a heat generating unit or a heat dissipating unit.

In the fluid communicating structure above, the operation portion is a push unit, a thrust unit, a linking unit, a handle, a labor-saving structure, a lever structure, a track structure, a motion structure, a structure with a movement space, a door, rotating unit, a track, a rod, a column, a bolt, or a structure that can assemble two bodies or coordinate with the flow channel and has a reserved portion, or the operation portion is a lever structure or a labor-saving structure, so that the operation portion is assembled at the two bodies and links or operates the block unit, or the operation portion and one of the bodies are provided with a lever structure in between.

In the fluid communicating structure above, the operation portion is provided at one of the bodies to join or combine the operation portion at the other body, and the operation portion pushes, connects or is assembled at the block unit, or the operation portion is the block unit, or the operation portion and the block unit are a formed integral, or the block unit is caused to enter the other body to open or close the flow channel.

In the fluid communicating structure above, the operation portion is disposed at one of the bodies to join or combine the operation portion at the other body, the operation portion pushes the block unit having an elastic force to have the block unit enter the other body so as to open or close the flow channel, and the elastic force of the block unit pushes the operation portion to join or combine the operation portion at the other body.

In the fluid communicating structure above, the operation portion is a lever structure or a labor-saving structure to assemble the operation portion at the two bodies and to link or operate the block unit.

In the fluid communicating structure above, the two operation portions are combined as a lever structure, each of the operation portions is provided with a coupling portion, and the operation portions are joined, combined or fixed by the coupling portions when close to each other during an operation, so as to fix positions of the bodies or the block unit.

In the fluid communicating structure above, the two operation portions are combined as a lever structure, the operation portions are respectively bolted at one of the bodies and the block unit, and the operation portions have a movement space where they interact with each other to implement a lever movement, so that the operation portions operate the block unit and assemble the two bodies.

In the fluid communicating structure above, the block unit and the operation portion are assembled with each other, or the block unit and the operation portion are a formed integral.

In the fluid communicating structure above, the operation portion is provided with at least one fastener, and the fastener and the operation portion are linked and engaged at the other body.

In the fluid communicating structure above, the fastener is elastically engaged at the other fastener of the other body, or the fastener or the other fastener is provided with an operation portion operable to engage the two bodies, or the fastener or the other fastener is provided with a guide portion which guides to engage the two bodies, and the guide portion is a sloped surface, an arched surface or a curved surface, or the fastener or the other fastener is provided with a second elastic element which elastically pushes to reciprocally open and close the fastener or the other fastener.

In the fluid communicating structure above, the fastener includes a head, or the fastener includes a head rotatable to change an engagement position.

In the fluid communicating structure above, the fastener is two in number, and the fasteners are linked with the other body.

In the above fluid joint structure, the operation portion and one of the bodies are provided with a lever structure in between.

In the fluid communicating structure above, the block unit of the body operates an operation portion to open or close the flow channel, and the body is provided on an inside thereof with an absorbing unit that absorbs a liquid.

In the fluid communicating structure above, the body or the operation portion is provided with a check portion, which serves as a check for a limitation of a fluid on an inside or outside of the body.

In the fluid communicating structure above, a monitor, a CCD, a visual system or an artificial intelligence (AI) apparatus is disposed at the check portion, around the check portion, or a corresponding check position corresponding to the check portion, so as to perform checking.

In the fluid communicating structure above, the body is two in number, and one of the bodies is provided with a tool which drives the block unit to enter the other body.

In the fluid communicating structure above, the body or the operation portion is provided with an alignment portion, which is for alignment to engage a fastener.

In the fluid communicating structure above, the body and the operation portion are provided with a first elastic element in between, and the first elastic element presses a fluid block unit to stop a fluid.

In the fluid communicating structure above, the body, the block unit and the operation portion are detachably combined with one another, and the block unit and the operation portion are movably assembled by a bolt, or the body, the block unit and the operation portion are detachably combined with one another to maintain and repair or replace a component of the fluid communicating structure.

The fluid communicating structure above further includes a lever structure, which includes a rotating portion and a lever portion. One end of the lever portion is assembled at one of the bodies, and the other end of the lever portion is assembled at the operation portion, so as to push the operation portion to move by rotating the rotating portion, or to push the operation portion to engage at the other body.

In the fluid communicating structure above, the rotating portion and the lever portion are assembled and linked by a shaft.

In the fluid communicating structure above, the body is two in number, one of the bodies is provided with a motion member having a track, and the track is fitted into a fastener or a fastening portion of the body that is pulled close, so as to assemble the two bodies to open the flow channel.

In the fluid communicating structure above, the motion member is movably disposed at one of the bodies by a shaft, and the motion member is rotated to fit the track into a fastener or a fastening portion of the other body that is pulled close.

In the fluid communicating structure above, the body is two in number, wherein one body, one block unit or one operation portion is provided with a motion member.

In the fluid communicating structure above, the body is two in number, wherein one body, one block unit or one operation portion provided with a motion member. The motion member includes a track which is fitted into a fastener or a fastening portion of the other body that is pulled close, so that the two bodies open the flow channel, or the motion member is movably disposed at one body, one block unit or one operation portion by a shaft, or the motion member includes a positioning portion, and one body, one block unit or one operation portion includes a corresponding positioning portion, so as to fix a position of the motion member by the positioning portion and the corresponding positioning portion when the fastener or the fastening portion of the other body is pulled close.

The present disclosure further provides a fluid communicating method, wherein the flow channel is closed by the block unit and the flow channel is opened by the block unit so as to communicate a fluid.

The present disclosure further provides another fluid communicating method, wherein two bodies are engaged by the fastener and then one block unit or two block units are opened to accordingly open the flow channel and communicate a fluid, or the body and the object are engaged by the fastener, and then one block unit or two block units are opened to accordingly open the flow channel and communicate a fluid.

The present disclosure further provides another fluid communicating method, wherein two bodies are engaged by the fastener or the body and the object are engaged by the fastener so that the two block units respectively coordinate with the first elastic elements to push against each other, and then the block units are opened to accordingly open the flow channel and communicate a fluid, or two bodies are engaged by the fastener or the body and the object are engaged by the fastener, so that one of the block units pushes against the other block unit coordinating with a first elastic element to accordingly open the flow channel and communicate a fluid.

The present disclosure further provides another fluid communicating method, wherein two block units and two bodies are included, the bodies are first coupled by the fastener or the fastener and then the block units are opened, or the block units are first closed and then the fasteners are opened, or the fastener is open, or the bodies are opened.

The present disclosure further provides another fluid communicating method, wherein two block units and two bodies are included, one of the block unit is pushed by a first elastic element toward a communicating direction to a position at which the flow channel is closed, the other block unit is pushed by the other first elastic element in a direction opposite to the communicating direction to a position at which the flow channel is closed, the block unit of the other first elastic element exerting a force in a direction opposite to the communicating direction pushes the other block unit to open two flow channels, and the block unit of the other first elastic element in the direction opposite to the communicating direction enters the other body.

The present disclosure further provides another fluid communicating method, wherein two block units and two bodies are included, one of the block units is pushed by a first elastic element toward a communicating direction to a position at which the flow channel is closed, the other block unit limited at a position at which the flow channel is closed, a force is exerted on this block unit to push the other block unit to open the two flow channels, and this block unit enters the other body.

The present disclosure further provides another fluid communicating method, wherein a force is exerted on one block unit to push another block unit so as to open two flow channels, and this block unit enters the other body.

The present disclosure further provides another fluid communicating method, wherein the flow channel is closed by the block unit and then the flow channel is opened by the block unit to accordingly communicate a fluid, and a position at which the flow channel enters the body or a position at which the flow channel is combined with the block unit is at a different height or a different angle, or the block unit and the flow channel are located at different angles or in different directions, or the block unit and the flow channel form an angle of 90 degrees, or the block unit and the flow channel form an angle between 170 degrees and 10 degrees.

The present disclosure further provides another fluid communicating method, wherein two bodies are engaged by the fastener and then one block unit or two block units are opened to accordingly open the flow channel and communicate the fluid, or the body and the object are engaged by the fastener and then one block unit or two block units are opened to accordingly open the flow channel and communicate a fluid, a position at which the flow channel enters the body or a position at which the flow channel is combined with the block unit is at a different height or a different angle, or the block unit and the flow channel are located at different angles or in different directions, or the block unit and the flow channel form an angle of 90 degrees, or the block unit and the flow channel form an angle between 170 degrees and 10 degrees.

Thus, the fluid communicating structure and the communicating method thereof of the present disclosure enable a required fluid to flow stably with flow guidance of a body.

### BRIEF DESCRIPTION OF THE DRAWINGS

FIG. 1 is an exploded schematic diagram of a fluid communicating structure according to a first embodiment of the present disclosure.

FIG. 2 is a schematic diagram of a state of use of a fluid communicating structure according to the first embodiment of the present disclosure.

FIG. 3 is a schematic diagram of a fluid communicating structure according to a second embodiment of the present disclosure.

FIG. 4 is a schematic diagram of a fluid communicating structure according to a third embodiment of the present disclosure.

FIG. 5 is a schematic diagram of a fluid communicating structure according to a fourth embodiment of the present disclosure.

FIG. 6 is a schematic diagram of a fluid communicating structure according to a fifth embodiment of the present disclosure.

FIG. 7 is a schematic diagram of a fluid communicating structure according to a sixth embodiment of the present disclosure.

FIG. 8 is a schematic diagram of a fluid communicating structure according to a seventh embodiment of the present disclosure.

FIG. 9 is a schematic diagram of manufacturing of a body the present disclosure.

FIG. 10 is a schematic diagram of a fluid communicating structure according to an eighth embodiment of the present disclosure.

FIG. 11 is a schematic diagram of a fluid communicating structure according to a ninth embodiment of the present disclosure.

FIG. 12 is a schematic diagram of a fluid communicating structure according to a tenth embodiment of the present disclosure.

FIG. 13 is a schematic diagram of a fluid communicating structure according to an eleventh embodiment of the present disclosure.

FIG. 14 is a schematic diagram of a fluid communicating structure according to a twelfth embodiment of the present disclosure.

FIG. 15 is a schematic diagram of a fluid communicating structure according to a thirteenth embodiment of the present disclosure.

FIG. 16 is a schematic diagram of a fluid communicating structure according to a fourteenth embodiment of the present disclosure.

FIG. 17 is a schematic diagram of a fluid communicating structure according to a fifteenth embodiment of the present disclosure.

FIG. 18 is a schematic diagram of a fluid communicating structure according to a sixteenth embodiment of the present disclosure.

FIG. 19 is a schematic diagram of a fluid communicating structure according to a seventeenth embodiment of the present disclosure.

FIG. 20 is a schematic diagram of a fluid communicating structure according to an eighteenth embodiment of the present disclosure.

FIG. 21 is a schematic diagram of a fluid communicating structure according to a nineteenth embodiment of the present disclosure.

FIG. 22 is a schematic diagram of a fluid communicating structure according to a twentieth embodiment of the present disclosure.

FIG. 23 is a schematic diagram of a fluid communicating structure according to a twenty-first embodiment of the present disclosure.

FIG. 24 is a schematic diagram of a fluid communicating structure according to a twenty-second embodiment of the present disclosure.

FIG. 25 is a schematic diagram of a fluid communicating structure according to a twenty-third embodiment of the present disclosure.

FIG. 26 is a schematic diagram of a fluid communicating structure according to a twenty-fourth embodiment of the present disclosure.

FIG. 27 is a schematic diagram of a fluid communicating structure according to a twenty-fifth embodiment of the present disclosure.

FIG. 28 is a schematic diagram of a fluid communicating structure according to a twenty-sixth embodiment of the present disclosure.

FIG. 29 is a schematic diagram of a fluid communicating structure according to the twenty-sixth embodiment of the present disclosure.

FIG. 30 is a schematic diagram of a fluid communicating structure according to a twenty-seventh embodiment of the present disclosure.

FIG. 31 is a schematic diagram of a fluid communicating structure according to a twenty-eighth embodiment of the present disclosure.

FIG. 32 is a first schematic diagram of a fluid communicating structure according to a twenty-ninth embodiment of the present disclosure.

FIG. 33 is a second schematic diagram of a fluid communicating structure according to the twenty-ninth embodiment of the present disclosure.

FIG. 34 is a schematic diagram of a fluid communicating structure according to a thirtieth embodiment of the present disclosure.

FIG. 35 is a schematic diagram of a fluid communicating structure according to a thirty-first embodiment of the present disclosure.

FIG. 36 is a schematic diagram of a fluid communicating structure according to a thirty-second embodiment of the present disclosure.

FIG. 37 is a schematic diagram of a fluid communicating structure according to a thirty-third embodiment of the present disclosure.

FIG. 38 is a schematic diagram of a fluid communicating structure according to a thirty-fourth embodiment of the present disclosure.

FIG. 39 is a schematic diagram of a fluid communicating structure according to a thirty-fifth embodiment of the present disclosure.

FIG. 40 is a schematic diagram of a fluid communicating structure according to a thirty-sixth embodiment of the present disclosure.

FIG. 41 is a schematic diagram of a fluid communicating structure according to a thirty-seventh embodiment of the present disclosure.

FIG. 42 is a schematic diagram of a fluid communicating structure according to a thirty-eighth embodiment of the present disclosure.

FIG. 43 is a schematic diagram of a fluid communicating structure according to a thirty-ninth embodiment of the present disclosure.

FIG. 44 is a schematic diagram of a fluid communicating structure according to a fortieth embodiment of the present disclosure.

FIG. 45 is a schematic diagram of a fluid communicating structure according to a forty-first embodiment of the present disclosure.

FIG. 46 is a schematic diagram of a fluid communicating structure according to a forty-second embodiment of the present disclosure.

FIG. 47 is a schematic diagram of a fluid communicating structure according to a forty-third embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

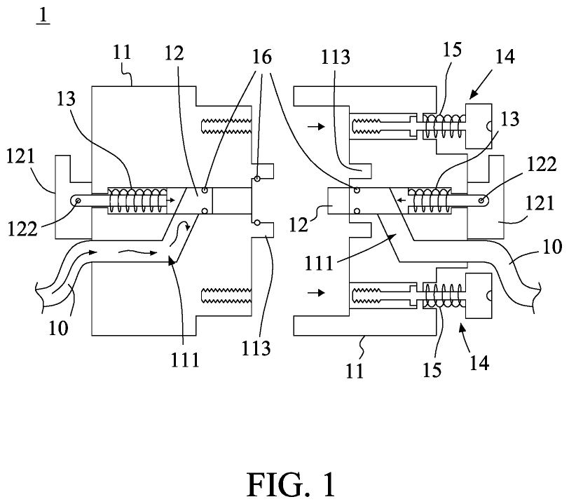

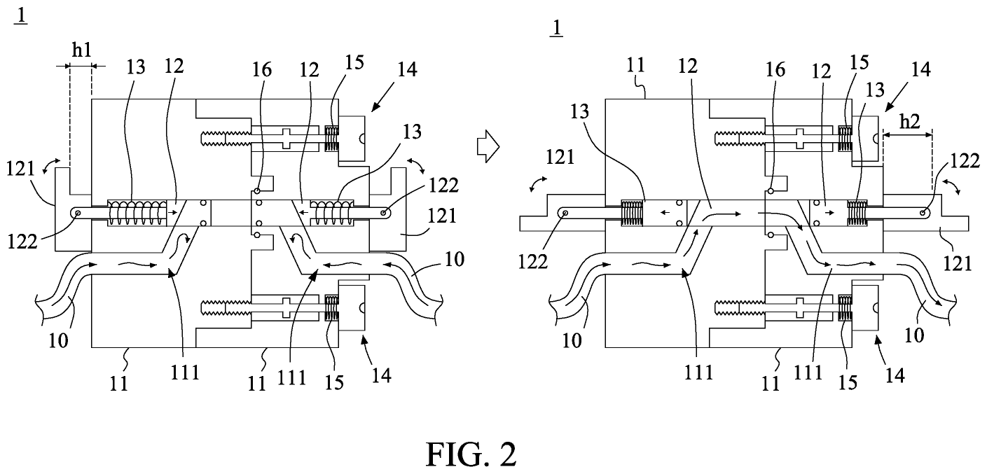

Referring to FIG. 1 to FIG. 2 showing a fluid communicating structure and a communicating method thereof of the present disclosure, the fluid communicating structure 1 includes at least one body 11 and at least one block unit 12.

The body 11 includes a flow channel 111.

The block unit 12 is movably combined with the body 11, and is configured to open or close the flow channel 111.

In one embodiment of the present disclosure, the fluid communicating structure 1 is applicable to data centers, cabinets, servers, memories, heat sinks, CPUs, GPUs, PCBs, ICs, connectors, industrial purposes or household purposes according to requirements. The body 11 can be two in number. Each of the bodies 11 is provided with a block unit 12, the flow channels 111 of the bodies 11 can be in communication with each other, and the block units 12 and the flow channels 111 are located at different angles or in different directions. The flow channels 111 can be respectively connected to pipes 10 which can be liquid pipes or gas pipes, so that a liquid (or air) can be guided by one of the pipes 10 into the flow channel 111 of one of the bodies 11 and then guided out from the flow channel 111 of the other body 11 to another pipe 10, further enabling the required liquid to flow stably under guided flow provided by the bodies 11.

In the fluid communicating method of the present disclosure, the flow channels 111 are first respectively closed by the block units 12, and then the block units 12 are moved to open the flow channels 111, so that a fluid flows from the flow channel 111 of one of the bodies 11 toward the flow channel 111 of the other body 11, thereby communicating the required fluid by the bodies 11 (wherein the fluid can be a liquid, a gas, oil, water, a liquid coolant, a water coolant or a chemical substance). Thus, the required fluid is enabled to flow stably under guided flow provided by the flow channels 111 of the bodies 11.

In addition to the embodiments above, in one embodiment of the present disclosure, each of the bodies 11 and each of the block units 12 are provided with a first elastic element 13 in between. The first elastic elements 13 locate the block units 12 to be at open positions of the flow channels 111 to communicate the required fluid, or the first elastic elements 13 locate the block units 12 to be at closed positions of the flow channels 111 to enclose the required fluid.

In addition to the embodiments above, in one embodiment of the present disclosure, each of the block units 12 is provided with an operation portion 121, and the operation portions 121 operate the block units 12 to operate. Each of the operation portions 121 and the each of the block units 12 can be movably assembled by a bolt 122, and the operation portions 121 and the bodies 11 have a first height h1 and a second height h2 in between, so that the operation portions 121 operate the block units 12 to operate at the first height h1 or the second height h2.

On the basis of the embodiments above, when the first elastic elements 13 are elastically released, the operation portions 121 are located at the positions at the first height h1 at this point, and the block units 12 can be located at the closed positions of the flow channels 111 to enclose the fluid in the flow channels 111. To put to use, a force can be exerted on the operation portions 121 to locate the operation portions 121 at the positions at the second height h2, so that the operation portions 121 respectively drive the block units 12 to operate, and meanwhile the first elastic elements 13 are compressed to locate the block units 12 at the open positions of the flow channels 111 to communicate the required fluid. Thus, the required fluid is enabled to flow stably under guided flow provided by the flow channels 111 of the bodies 11.

In addition to the embodiments above, in one embodiment of the present disclosure, the body 11 is provided with at least one fastener 14, and the fastener 14 is two in number in this embodiment. Each of the fasteners 14 and each of the bodies 11 are provided with a second elastic element 15 in between. The second elastic elements 15 respectively exert elastic forces to pull tight engagement of the two bodies 11. Each of the fasteners 14 can be a thread, a column, an outer fastener, an elastic fastener, an inner fastener, a sphere or a bead. Thus, the bodies 11 can be securely combined into a packed state by the fasteners 14 to facilitate the fluid to stably flow with flow guidance through the flow channels 111 of the bodies 11. When the fluid is communicated, one of the block units 12 or both of the block units 12 can be opened according to requirements to accordingly open the flow channels 111 and communicate the fluid, thereby enabling the present disclosure to better meet actual application requirements.

In addition to the embodiments above, in one embodiment of the present disclosure, in addition to serve for engagement of the two bodies 11, the fasteners 14 further serve for engagement for the body 11 and an object. Moreover, the second elastic elements 15 respectively exert elastic forces to pull tight the body 11 and the object, and the object can be regarded as the other body 11 or another associated external object. Thus, the present disclosure is enabled to better meet actual application requirements.

In addition to the embodiments above, in one embodiment of the present disclosure, the block units 12 can be parallel to the bodies 11, or the block units 12 can protrude from the bodies 11, or the block units 12 can be recessed into the bodies 11, or the block units 12 can be elastically parallel to the bodies 11, or the block units 12 can elastic protrude from the bodies 11, or the block units 12 can be elastically recessed into the bodies 11. Thus, the present disclosure is enabled to better meet actual application requirements.

In addition to the embodiments above, in one embodiment of the present disclosure, positions at which the flow channels 111 enter the bodies 11 and positions at which the flow channels 111 are combined with the block units 12 are at different heights (or different angles). Moreover, the block unit 12 and the flow channel 111 can also be located at different angles or in different directions, or the block unit 11 and the flow channel 111 form an angle of 90 degrees, or the block unit 12 and the flow channel 111 form an angle between 170 degrees and 10 degrees. Thus, required fluid is enabled to flow stably under guided flow provided by the flow channels 111 of the bodies 11.

In addition to the embodiments above, in one embodiment of the present disclosure, each of the bodies 11 or the block units 12 is provided with at least one fluid block unit 16, and each of the fluid block units 16 can be a ring unit (for example, an O-ring, a waterstop ring, a rubber ring or a washer to meet actual application requirements), an elastic unit, a rubber unit, a silicon unit, a fluid absorbing unit or a bulk unit, or the fluid block unit 16 can be disposed at any position through which the fluid passes, or the fluid block unit 16 can be disposed at any motion position of the block unit 12 or the body 11. Thus, in coordination with the fluid block units 16, the block units 12 and the flow channels 111 form a packed state to prevent any leakage when the fluid is under guided flow or is not under guided flow, so as to facilitate the fluid to flow stably under guided flow provided by the flow channels 111 of the bodies 11.

In addition to the embodiments above, in one embodiment of the present disclosure, the block units 12 and the flow channels 111 are located at different angles or in different directions.

In addition to the embodiments above, in one embodiment of the present disclosure, the body 11 is two in number, or the body 11 is two in number and each of the bodies 11 has a block unit 12, or the body 11 is two in number and one of the bodies 11 has a block unit 12. Thus, the present disclosure is enabled to better meet actual application requirements.

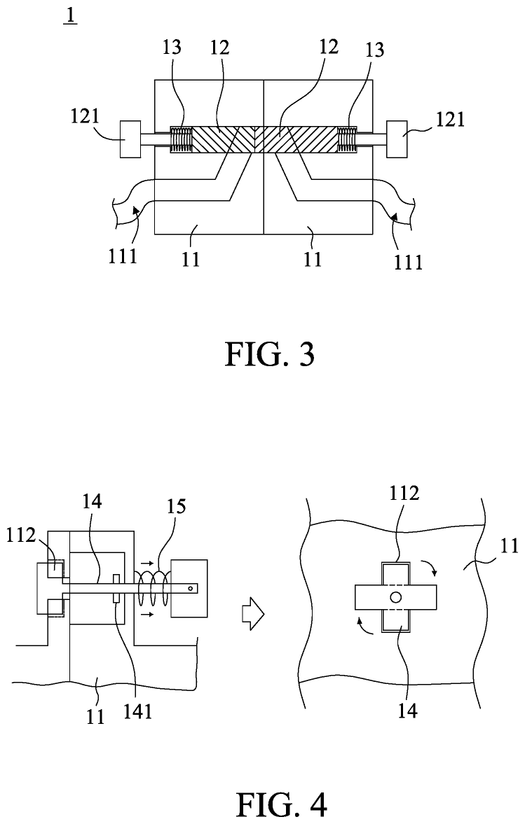

As shown in FIG. 3, in one embodiment of the present disclosure, the differences from the embodiments above are that, the block unit 12 is two in number, and each of the block units 12 is provided with a first elastic element 13. The first elastic elements 13 respectively exert forces to elastically push the block units 12 against each other and be located at the closed positions of the flow channels 111. Thus, the block units 12 can be located at the closed positions of the flow channels 111 by pushing of the first elastic elements 13, so as to prevent any leakage when the fluid is not under guided flow. Moreover, when the block unit 12 is two in number, one of the block units 12 can be provided with one first elastic element 13, so that the first elastic element 13 pressurizes the block units 12 to push against each other to locate at the closed positions of the flow channels 111.

Moreover, when the fluid is communicated, the two block units 12 can first coordinate with the respective first elastic elements 13 to push each against each other so that the block units 12 first are not at the closed positions, and then the block units 12 are opened to accordingly open the flow channels 11 and communicate the fluid, thereby enabling the present disclosure to better meet actual application requirements.

As shown in FIG. 4, in one embodiment of the present disclosure, the differences from the embodiments above are that, the fasteners 14 are outer fasteners and are inserted into one of the bodies 11 and rotated, so that the fasteners 14 are fitted into body limiting portions 112 of the bodies 11. Each of the fasteners 14 is provided with a stop portion 141, and the stop portions 141 limit and stop the bodies 11 against each other so that the stop portions 141 limit engagement positions of the fasteners 14. Thus, in coordination with the fasteners 14 and the body limiting portions 112, the bodies 11 are securely combined to form a packed state, so as to facilitate the fluid to flow stably under guided flow provided by the flow channels 111 of the bodies 11.

Moreover, each of the body limiting portions 112 can be a two-layered limiting structure so as to limit positions of the stop portions 141 and the fasteners 14. Thus, the fasteners 14 can coordinate with the body limiting portions 122 by the stop portions 141 for secure engagement, thereby enabling the present disclosure to better meet actual application requirements.

In addition to the embodiments above, in one embodiment of the present disclosure, two bodies 11 are engaged by the fasteners 14 and then one block unit 12 or two block units 12 are opened to accordingly open the flow channel 11 and communicate a fluid, or the body 11 and the object are engaged by the fasteners 14, and then one block unit 12 is used to push the other block unit 12 coordinating with a first elastic element 13 to accordingly open the flow channel 111 and communicate a fluid, thereby enabling the present disclosure to better meet actual application requirements.

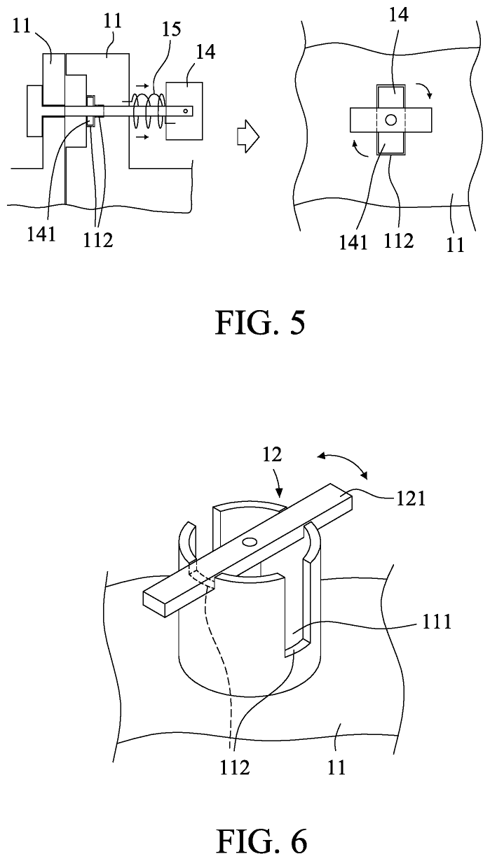

As shown in FIG. 5, in one embodiment of the present disclosure, the differences from the embodiments above are that, each of the bodies 11 and each of the fasteners 14 are provided with a second elastic element 15 in between, and the second elastic elements can be torsion springs. Two ends of the second elastic elements 15 are respectively fixed at the bodies 11 and the fasteners 14, so that the fasteners 14 respectively coordinate with the second elastic elements 15 to perform automatic back fastening, and are stopped against each other by using the stop portions 141 and the body limiting portions 112 of the bodies 11, so that the stop portions 141 limit the engagement positions of the fasteners 14. Thus, in coordination with the fasteners 14 and the body limiting portions 112, the bodies 11 can be securely combined into a packed state, so as to facilitate the fluid to flow stably under guided flow provided by the flow channels 111 of the bodies 11.

As shown in FIG. 6, in one embodiment of the present disclosure, the differences from the embodiments above are that, each of the body limiting portions 112 can be a two-layered limiting structure so as to limit positions of the operation portions 121 of the block units 12. Thus, the block units 12 can coordinate with the body limiting portions 112 to open or close the flow channels 111, thereby enabling the present disclosure to better meet actual application requirements.

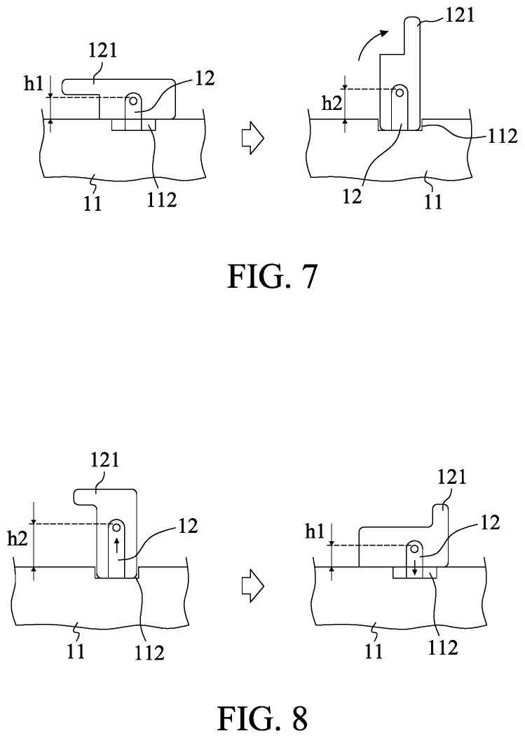

As shown in FIG. 1, FIG. 7 and FIG. 8, in one embodiment of the present disclosure, the differences from the embodiments above are that, each of the bodies 11 is provided with a body limiting portion 112, and the block units 12 respectively coordinate with the body limiting portions 112 so as to limit at the open positions (or closed positions) of the flow channels 111.

On the basis of the embodiments above, when the operations portions 121 are located at the positions at the first height h1, the block units 12 are used to respectively coordinate with the body limiting portions 112 for limiting to locate the block units 12 at the open positions (or the closed positions) of the flow channels 111, so as to communicate (or enclose) the fluid in the flow channels 111. When the operation portions 121 are located at the positions at the second height h1, the operation portions 121 are used to respectively drive the block units 12 to operate and to locate the block units 12 at the closed positions (or the open positions) of the flow channels 111, so as to enclose the fluid. Thus, the required fluid is enabled to flow stably under guided flow provided by the flow channels 111 of the bodies 11.

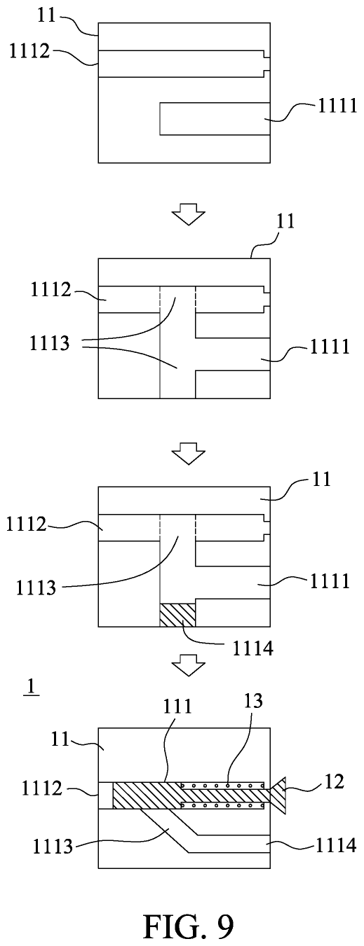

As shown in FIG. 9, in one embodiment of the present disclosure, the differences from the embodiments above are that, the flow channel 111 of the fluid communicating structure 1 includes an inlet flow channel 1111, an outlet flow channel 1112, a connecting flow channel 1113 and a sealing unit 1114. The connecting flow channel 1113 communicates the inlet flow channel 1111 and the outlet flow channel 1112. The sealing unit 1114 is disposed at the body 11, and seals the connecting flow channel 1113 and one side (for example, an outer side) of the body 11. The body 11 can be machined, milled, injection molded, de-waxed, split-edge locked, split-edge bonded, split-edge fastened or split-edge welding combined. Once the flow channel 111 of the body 11 is completed, the block unit 12 and the first elastic element 13 are then prepared. Thus, the required flow channel 111 can be formed at the body11, thereby enabling the present disclosure to better meet actual application requirements.

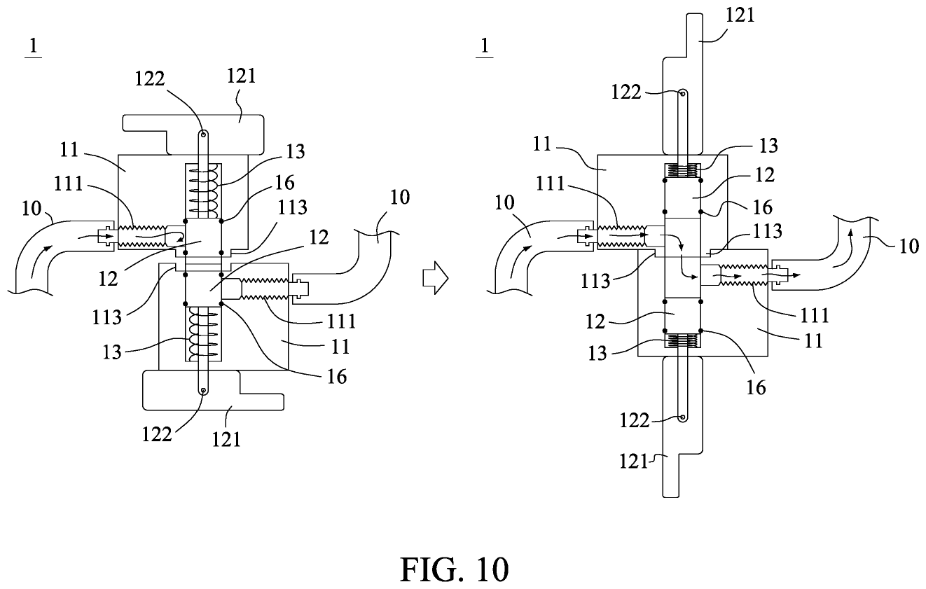

As shown in FIG. 10, in one embodiment of the present disclosure, the differences from the embodiments above are that, each of the bodies 11 is provided with only an alignment connecting portion 113 (but without the fasteners 14), and the bodies 11 are alignment connected, aligned or prevented from rotation by using the alignment connecting portions 113, thereby enabling the present disclosure to better meet actual application requirements.

In addition to the embodiments above, in one embodiment of the present disclosure, the first elastic element 13 normally pushes against the block unit 12 and the body 11, so that the block unit 12 is located at a position for stopping the flow channel 111.

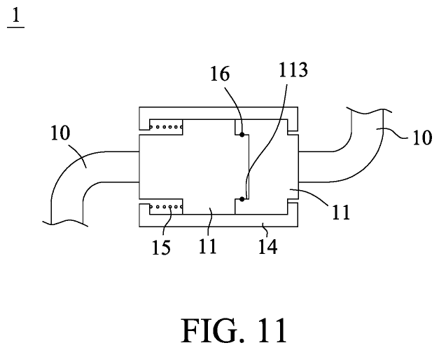

As shown in FIG. 11, in one embodiment of the present disclosure, the differences from the embodiments above are that, each of the bodies 11 is provided with an alignment connecting portion 113, the bodies 11 are engaged by a fastener 14, the bodies 11 are alignment connected, aligned or prevented from rotation by using the alignment connecting portions 113, and the second elastic element 15 abuts between one of the bodies 11 and the fastener 14, thereby enabling the present disclosure to better meet actual application requirements.

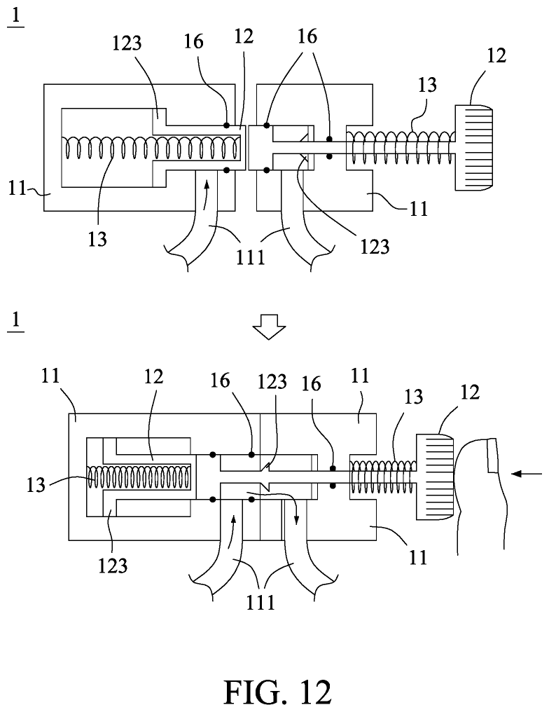

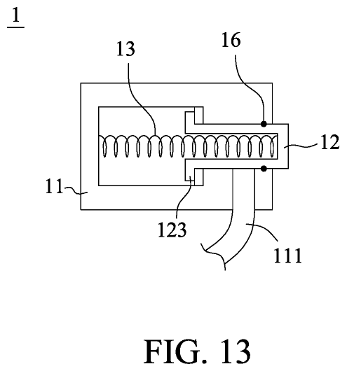

As shown in FIG. 12 and FIG. 13, in one embodiment of the present disclosure, the differences from the embodiments above are that, the first elastic elements 13 normally abut against the block units 12 and the bodies 11 so that the block units 12 are located at positions for stopping the flow channels 11, and the block units 12 elastically push against each other by the first elastic elements 13 so that the block units 12 respectively open or close the flow channels 111. In the communicating method, a force is exerted on one block unit 12 to push the other block unit 12 so as to open two flow channels 111, wherein the block unit 12 enters the other body 11, thereby enabling the present disclosure to better meet actual application requirements.

In addition to the embodiments above, in one embodiment of the fluid communicating method of the present disclosure, one block unit 12 is pushed by the first elastic element 13 toward a communicating direction to the position at which the flow channel 111 is closed, the other block unit 12 is limited at a position at which the flow channel 111 is closed, a force is exerted on this block unit 12 to push the other block unit 12 to open two flow channels 111, and this block unit 12 enters the other body 11.

In addition to the embodiments above, in one embodiment of the fluid communicating method of the present disclosure, one of the block units 12 is pushed by the first elastic element 13 toward the communicating direction to a position at which the flow channel 111 is closed, the other block unit 12 is pushed by the other first elastic element 13 in a direction opposite to the communication direction to a position at which the flow channel 111 is closed, the block unit 12 of the first elastic element 13 exerting a force in a direction opposite to the communicating direction pushes the other block unit 12 to open the two channels 111, and the block unit 12 of the other first elastic element 13 in the direction opposite to the communicating direction enters the other body 11.

In addition to the embodiment above, in one embodiment of the present disclosure, one of the block units 12 is (or the block units 12 are) provided with a resist portion 123, and the resist portion 123 and the body 11 resist each other.

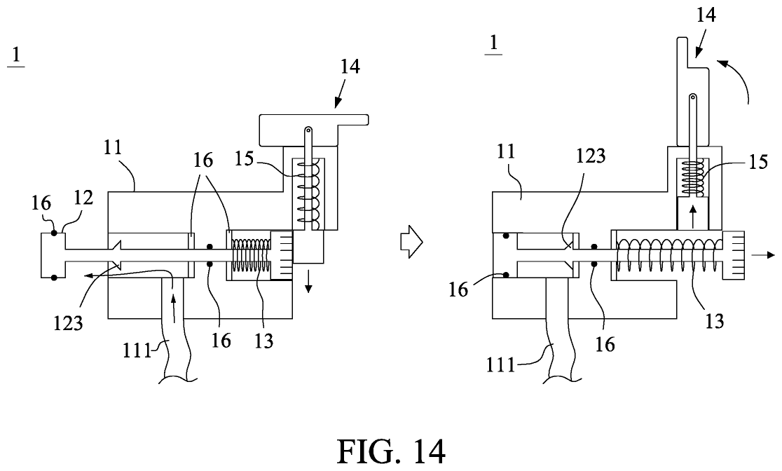

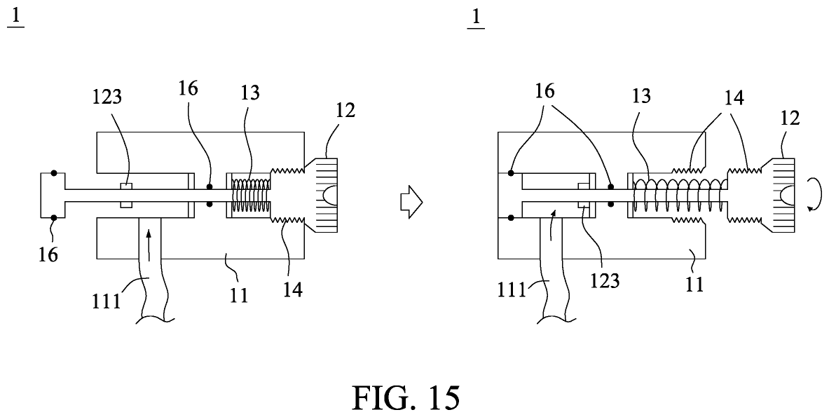

As shown in FIG. 14 and FIG. 15, in one embodiment of the present disclosure, the differences from the embodiments above are that, the body 11 (or the block unit 12) is provided with a fastener 14, which limits the block unit 12 to locate at a position at which the flow channel 111 is open or at a position at which the flow channel 111 is closed. The fastener 111 may be a column, a fastener, a thread, an elastic fastener, an inner fastener or an outer fastener, and the resistor portion 123 may be a structural design that guides a fluid, thereby enabling the present disclosure to better meet actual application requirements.

On the basis of the embodiments above, when the fluid communicating structure 1 of the present disclosure includes two block units 12 and two bodies 11, the bodies 11 are first coupled by the fasteners 14 and then the block units 12 are opened, or the block units 12 are first closed and then the fasteners 14 are opened or the bodies 11 are opened, thereby enabling the present disclosure to better meet actual application requirements.

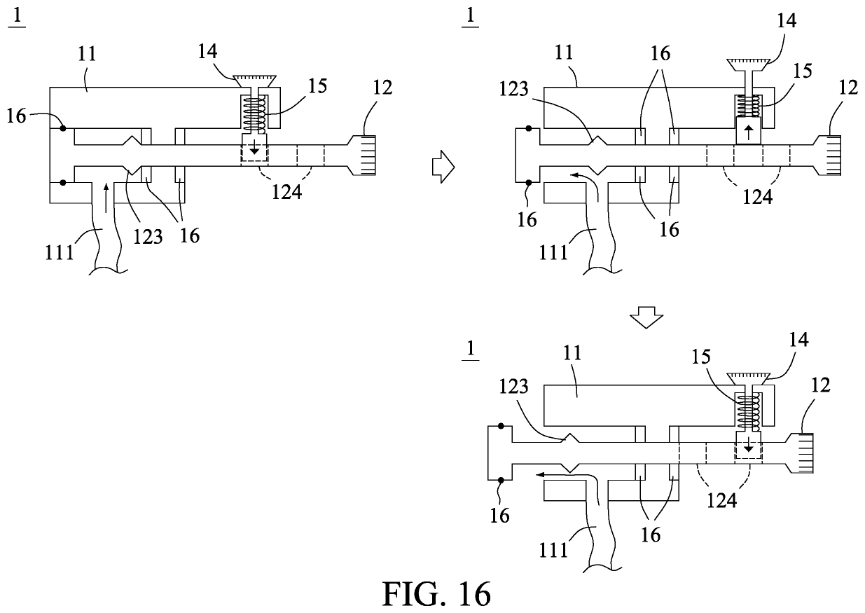

As shown in FIG. 16, in one embodiment of the present disclosure, the differences from the embodiments above are that, the block unit 12 of the fluid communicating structure 1 is provided with at least one block unit limiting portion 124, which is engaged with the fastener 14 disposed at the body 11 so as to limit the block unit 12 to locate a position at which the flow channel 111 is open or at a position at which the flow channel 111 is closed, thereby enabling the present disclosure to better meet actual application requirements.

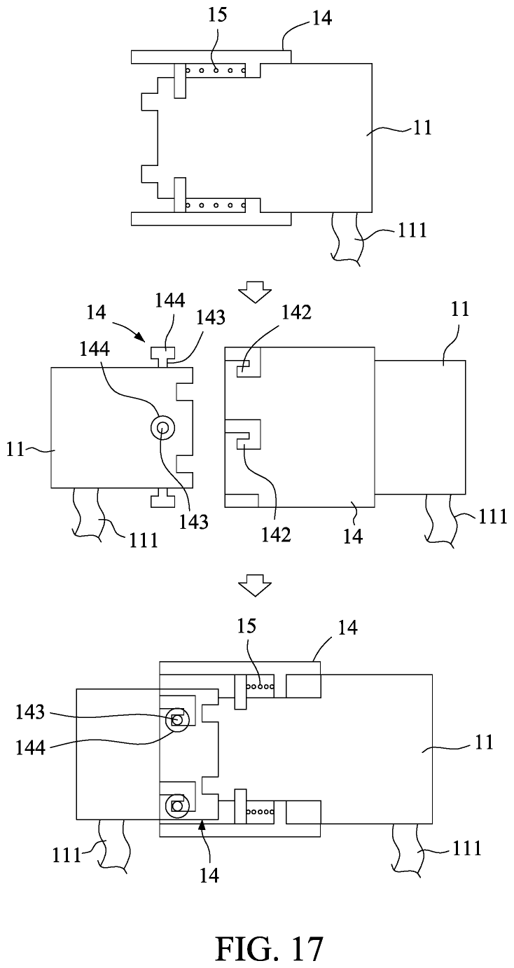

As shown in FIG. 17, in one embodiment of the present disclosure, the differences from the embodiments above are that, the body 11 is two in number, each of the bodies 11 includes a fastener 14 (or a fastening portion), and the bodies 11 are respectively engaged with each other by the fasteners 14 (or the fastening portions).

In addition to the embodiments above, in one embodiment of the present disclosure, the fastener 14 (or the fastening portion) of one of the bodies 11 is engaged with the fastener 14 (or the fastening portion) of the other body 11 by means of pressing of a second elastic element 15.

In addition to the embodiments above, in one embodiment of the present disclosure, the fastener 14 (or the fastening portion) of one of the bodies 11 includes a limiting portion 142, and the fastener 14 (or the fastening portion) of the other body 11 is engaged at the limiting portion 142.

In addition to the embodiments above, in one embodiment of the present disclosure, each of the fasteners 14 (or the fastening portions) is a limiting portion, a groove, a recess, a track, a protrusion or a hole, has a neck 143, has a head 144, is a column, or is a structure with an inverted hook.

On the basis of the embodiments above, the fastener 14 of one of the bodies 11 can have include a neck 143 and a head 144, and the fastener 14 of the other body 11 has a limiting portion 142. Thus, the fastener 14 of one of the bodies 11 can be fitted into the limiting portion 142 of the fastener 14 of the other body 11 by the neck 143, and the head 144 is used for limiting and stopping once the neck 143 is fitted into the limiting portion 142, so as to combine the two bodies 11 with each other.

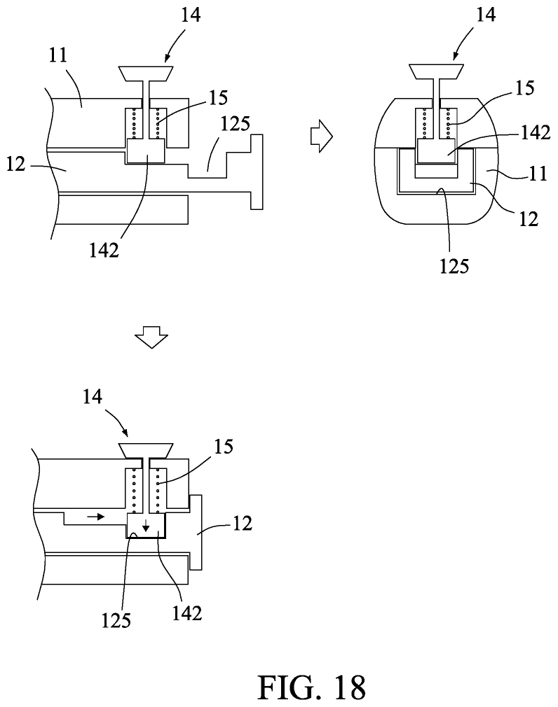

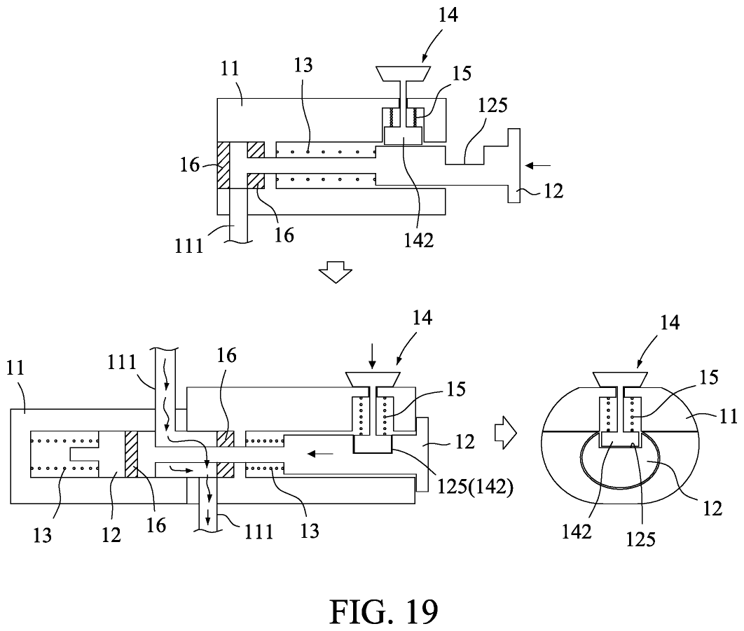

As shown in FIG. 18 and FIG. 19, in one embodiment of the present disclosure, the differences from the embodiments above are that, the block unit 12 (or the body 11) is provided with an anti-rotation portion 125, and the anti-rotation portion 125 prevents rotation of the body 11 (or the block unit 12), or the anti-rotation 125 prevents rotation of the fastener 14, or the anti-rotation 125 prevents rotation of an object. Moreover, in this embodiment, it is not necessary to provide the stop portion 125 of the embodiments above.

In addition to the embodiments above, in one embodiment of the present disclosure, the anti-rotation portion 125 is a structure abutting against the fastener 14, or the anti-rotation structure 125 is a stepped structure abutting against the fastener 14, or the anti-rotation portion 125 is an elastic structure abutting against the fastener 14, or the anti-rotation portion 125 is a structure that moves the fastener 14 to fit into a limiting portion 142, or the anti-rotation portion 125 is a structure that moves the block unit 12 and is fit into a limiting portion 142, or the anti-rotation portion 125 is a structure that moves the block unit 12 and then automatically elastically fits into a limiting portion 125.

On the basis of the embodiments above, when the block unit 12 is located at a position at which the flow channel 111 is open or at a position at which the flow channel 111 is closed, the limiting portion 142 of the fastener 14 is fitted into the anti-rotation portion by elastic pressing of the second elastic element 15, so that the block unit 12 achieves an effect of anti-rotation against the body 11 by using the anti-rotation 125 in coordination with the fastener 14, thereby enabling the block unit 12 to be securely located at a position at which the flow channel 111 is open or at a position at which the flow channel 111 is closed.

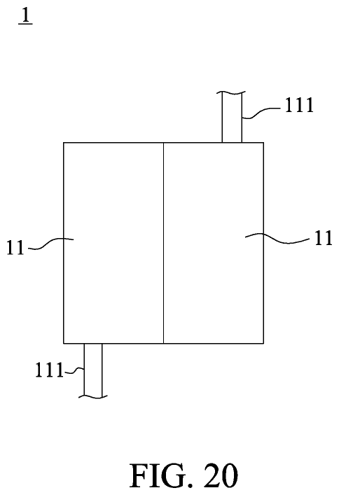

As shown in FIG. 20, in one embodiment of the present disclosure, the differences from the embodiments above are that, the body 11 is two in number, and the flow channels 111 of the bodies 11 are located in different directions, or the flow channels 111 of the bodies 11 are located at different angles, or motion directions of the block units 12 and the flow channels 111 correspondingly blocked are located in different directions, or motion directions of the block units 12 and the flow channels 111 correspondingly are located at different angles. Thus, with a staggered arrangement of the flow channels 111, the flow channels 111 to not interfere with each other, hence facilitating space planning of actual applications.

In addition to the embodiments above, in one embodiment of the present disclosure, the block units 12 and the flow channels 111 are located at different angles or in different directions, or the block units 12 and the flow channels 111 form an angle of 90 degrees, or the block units 12 and the flow channels 111 form an angle between 90 degrees and 30 degrees.

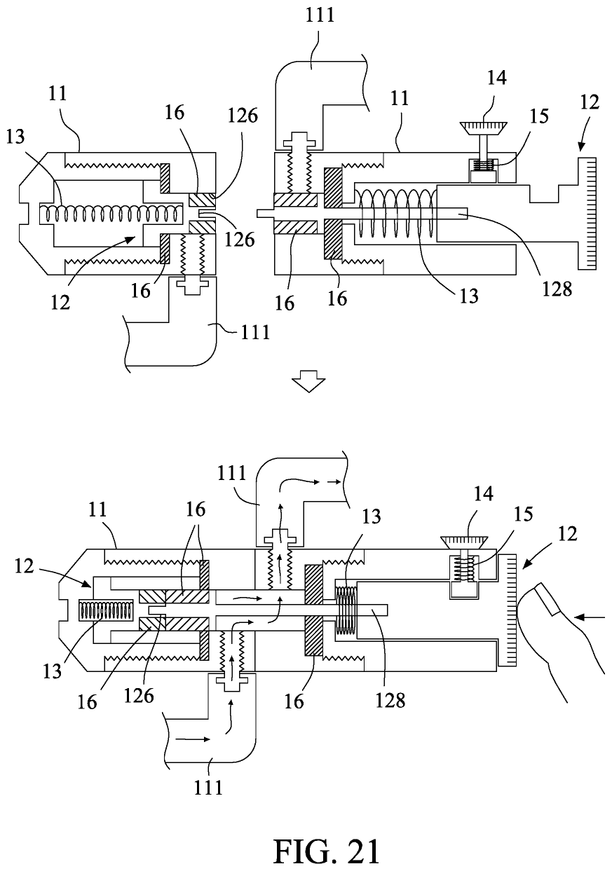

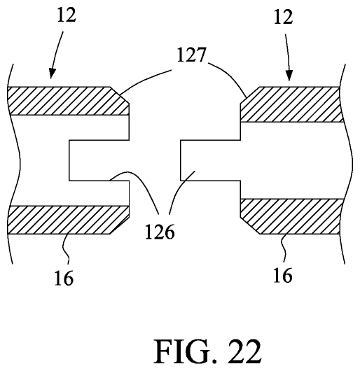

As shown in FIG. 21 and FIG. 22, in one embodiment of the present disclosure, the differences from the embodiments above are that, the block unit 12 is two in number, each of the block units 12 is provided with a corresponding coupling portion 126, and the block units 12 are alignment connected, limited, prevented from rotation, stabilized, aligned or engaged by using the corresponding coupling portions 126, respectively, thereby enabling the present disclosure to better meet actual application requirements.

In addition to the embodiments above, in one embodiment of the present disclosure, the block unit 12 provided with a guide angle 127 (an angle or an arc) to be better guided in the body 11, or be guided into the other body 11, or be guided in an object, thereby enabling the block units 12 of the present disclosure to better meet actual application requirements.

In addition to the embodiments above, in one embodiment of the present disclosure, the body 11 is a combination of at least two elements which can be combined by various methods, the method of the combination is lock combination in this embodiment, and at least one fluid block unit 16 is resisted, limited or pressed by the bodies 11 combined from at least two elements, thereby enabling the bodies 11 of the present disclosure to better meet actual application requirements.

In addition to the embodiments above, in one embodiment of the present disclosure, the block unit 12 is a combination of at least two elements which can be combined by various methods, the method of the combination is bolt combination, lock combination, engagement combination, rivet combination or expansion combination, and bolt combination by using an assembly portion 128 is disclosed in this embodiment, thereby enabling the block units 12 of the present disclosure to better meet actual application requirements.

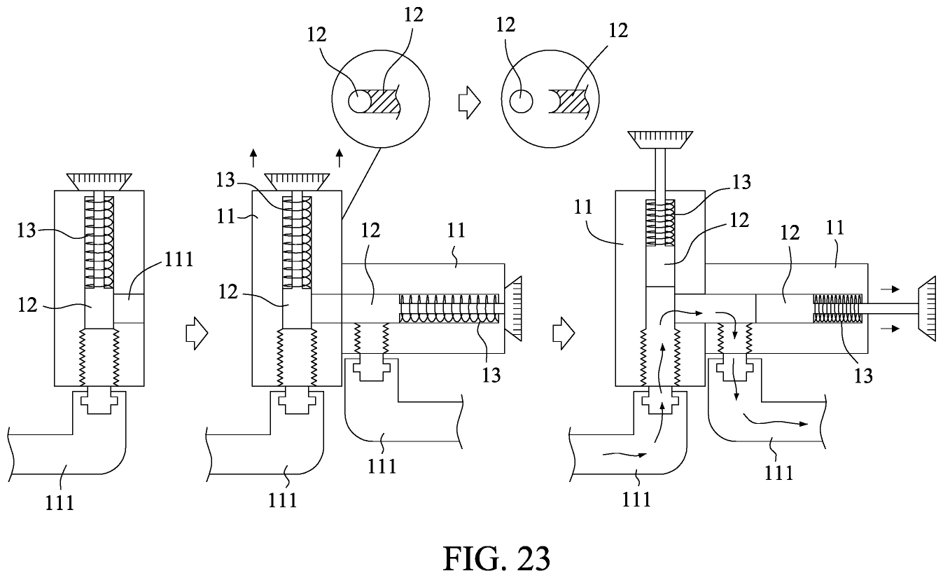

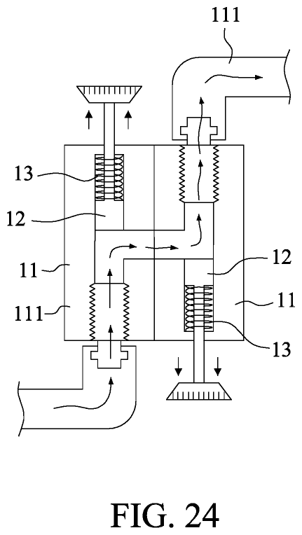

Referring to FIG. 23 and FIG. 24, in one embodiment of the present disclosure, the differences from the embodiments are that, the bodies 11 can be a combination in different directions or at different angles (as shown in FIG. 23); moreover, the block units 12 can also be disposed in different directions or at different angles (as shown in FIG. 24), thereby enabling the present disclosure to better meet actual application requirements.

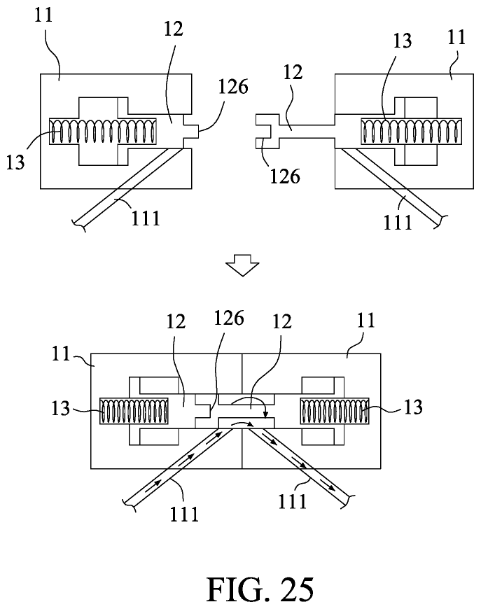

As shown in FIG. 25, in one embodiment of the present disclosure, the differences from the embodiments above are that, the block units 12 can push against each other by the corresponding coupling portions 126 so as to open the flow channels 111, thereby enabling the present disclosure to better meet actual application requirements.

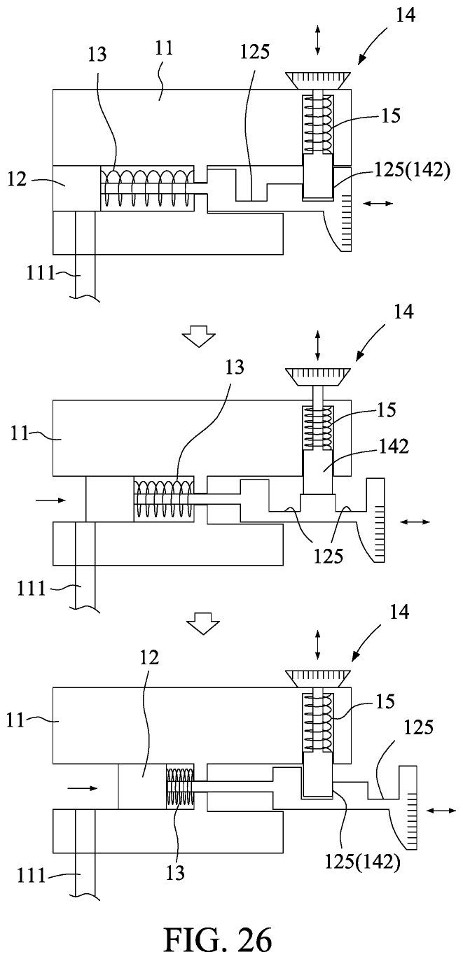

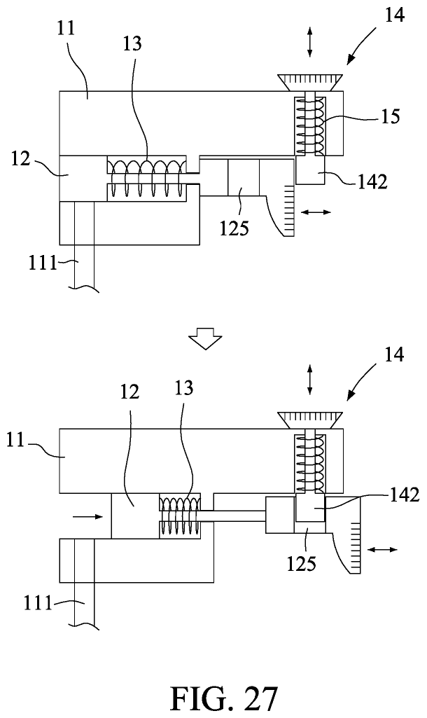

Referring to FIG. 26 and FIG. 27, in one embodiment of the present disclosure, the differences from the embodiments are that, the fastener 14 on the body 11 corresponding to the block unit 12 can be a safety switch (or a safety mechanism structure) according to requirements. When the limiting portion 142 of the fastener 14 is fitted into the anti-rotation portion 142 by elastic pressing of the second elastic element 15, the block unit 12 can be limited by the fastener 14 so that the block unit 12 operates only when the fastener 14 is opened, thereby enabling the present disclosure to better meet actual application requirements.

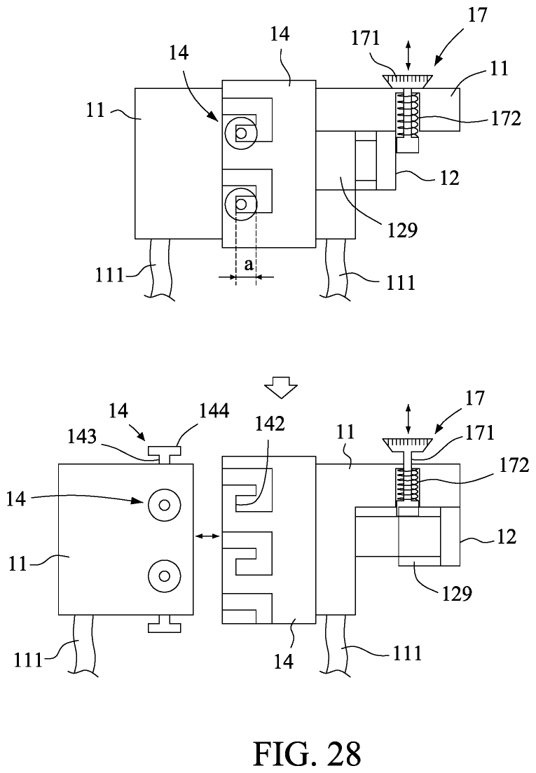

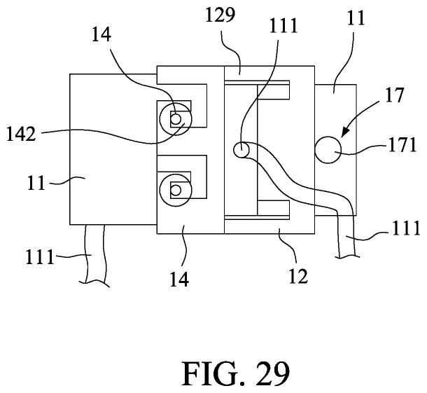

Referring to FIG. 28 and FIG. 29, in one embodiment of the present disclosure, the differences from the embodiments are that, at least one of the body 11 is provided with a safety mechanism structure 17 (the safety mechanism structure 17 can be replaced by the fastener 14 according to requirements). When the safety mechanism structure 17 and the block unit 12 are limited by each other, the two bodies 11 can be limited or the flow channels 111 can be opened, and when the safety mechanism structure 17 and the block unit 12 depart from each other, the two bodies 11 can be separated or the flow channels 111 can be closed.

In one embodiment of the present disclosure, the differences from the embodiments are that, the safety mechanism structure 17 includes a fastening member 171 and a third elastic element 172, and the safety mechanism structure 17 limits or departs from the block unit 12 by the coordination of fastening member 171 and the third elastic element 173, accordingly performing an operation required by the safety mechanism structure 171. Moreover, the block unit 12 is provided with a stop portion 129 which is configured to stop the fastener 14, thereby enabling the present disclosure to better meet actual application requirements.

In one embodiment of the present disclosure, the differences from the embodiments are that, the fastener 14 of one of the bodies 11 of this embodiment is fitted into the limiting portion 142 of the fastener 14 of the other body 11, and the head 144 serves for limiting and stopping once the neck 143 is fitted into the limiting portion, so as to combine the two bodies 11 with each other. Moreover, at least one of the fasteners 14 is provided with a motion distance a, and the safety mechanism structure 17 limits the block unit 12 so that the block unit 12 limits a position of the fastener14 at the motion distance a, and the safety mechanism structure 17 departs from the block unit 12 so that the block unit 12 closes the flow channel 111 and the fastener 14 moves in the motion distance a to separate the two bodies 11, thereby enabling the present disclosure to better meet actual application requirements.

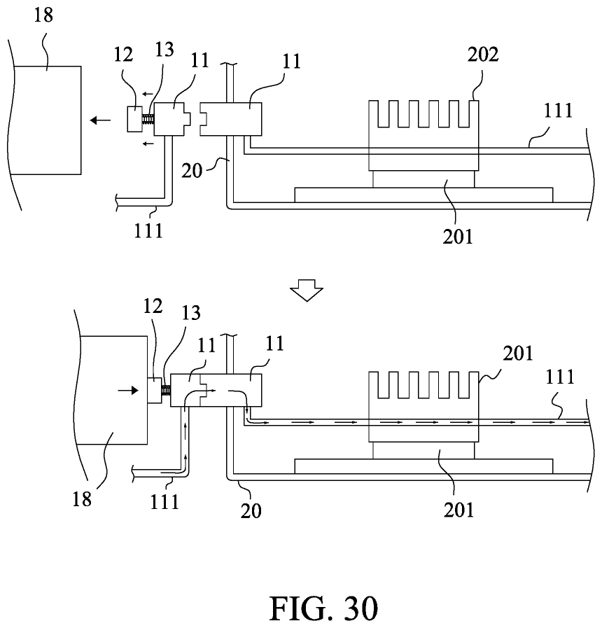

As shown in FIG. 30, in one embodiment of the present disclosure, the differences from the embodiments above are that, the body 11 in the fluid communicating structure 1 is two in number, and the block unit 12 of one of the bodies 11 operates by at least one operation portion 18 to open or close the flow channel 111, thereby enabling the present disclosure to better meet actual application requirements.

In one embodiment of the present disclosure, the differences from the embodiments above are that, one of the bodies 11 is disposed at an object 20, the object 20 is provided with a heat generating unit 201 and a heat dissipating unit 202, and the fluid in the flow channel 111 flows through the heat dissipating unit 202 so as to cool the heat generating unit 201, thereby enabling the present disclosure to better meet actual application requirements.

In one embodiment of the present disclosure, the differences from the embodiments above are that, the object 20 can be a server, a memory, a cabinet, a liquid cooling apparatus, the heat generating unit 201 or the heat dissipating unit 201 (wherein the heat generating unit 201 can be a chip, and the heat dissipating unit 202 can be a heat sink or a cooling liquid), thereby enabling the present disclosure to better meet actual application requirements.

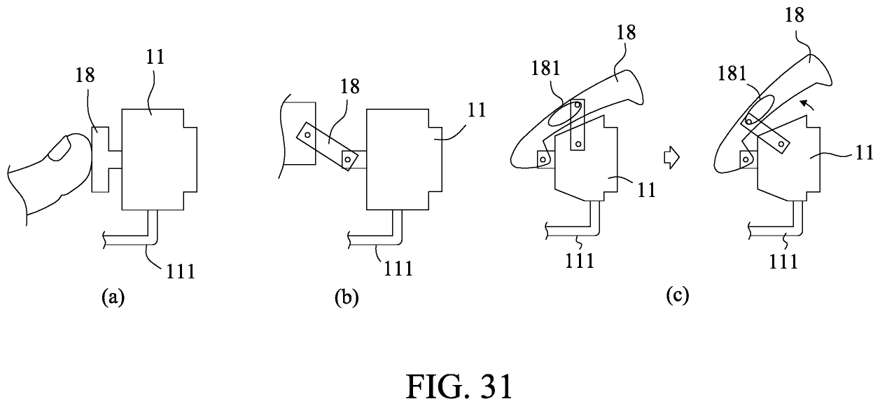

As shown in FIG. 31, in one embodiment of the present disclosure, the differences from the embodiments above are that, the operation portion 18 can be a push unit, a thrust unit (as shown by part a in FIG. 31), a linking unit (as shown by part b in FIG. 31), a handle (as shown by part c in FIG. 31), a labor-saving structure, a lever structure, a track structure, a motion structure, a structure with a movement space 18 such as part c shown in FIG. 31, a door, rotating unit, a track, a rod, a column, a bolt, or a structure that can assemble two bodies 11 or coordinate with the flow channel 111 and has a reserved portion, thereby enabling the present disclosure to better meet actual application requirements.

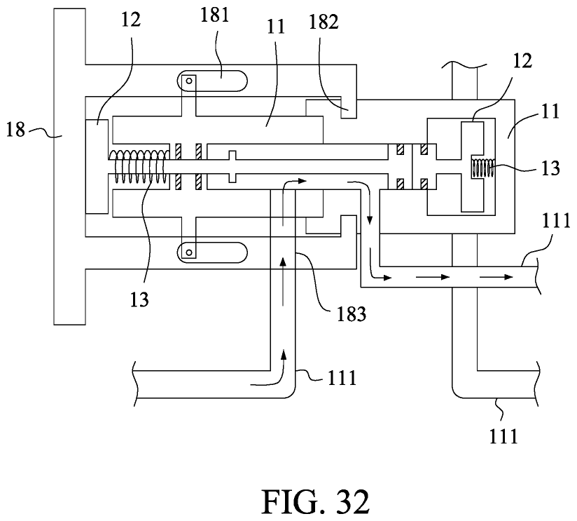

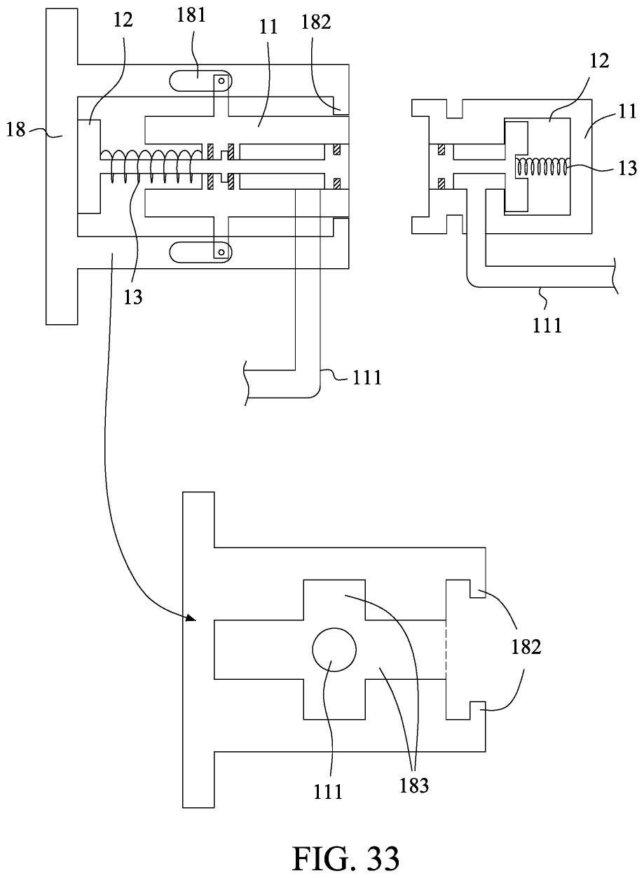

As shown in FIG. 32 and FIG. 33, in one embodiment of the present disclosure, the differences from the embodiments above are that, the operation portion 18 is disposed at one of the bodies 11 to join or combine the operation portion 18 at the other body 11 by a joining portion 182, and the operation portion 18 abuts against (or is assembled at) the block unit 12 to have the block unit 12 enter the other body 11 to open or close the flow channel 111, thereby enabling the present disclosure to better meet actual application requirements.

In one embodiment of the present disclosure, the differences from the embodiments above are that, the operation portion 18 is disposed at one of the bodies 11 to join or combine the operation portion 18 at the other body 11, the operation portion 18 pushes the block unit 12 having an elastic force, the block unit 12 can generate a pushing elastic force by the first elastic element 13 to have the block unit 12 enter the other body 12 so as to open or close the flow channel 111, and the operation portion 18 is pushed by the block unit 12 coordinating with an elastic force of the first elastic element 13 so that the operation portion 18 generates a pushing/pulling force and is joined or combined at the other body 11, thereby securely combining the two bodies and enabling the present disclosure to better meet actual application requirements.

In one embodiment of the present disclosure, the differences from the embodiments above are that, the operation portion 18 can be a structure for assembling the two bodies 11 or a structure coordinating with the flow channel 111 and having a reserved portion 183.

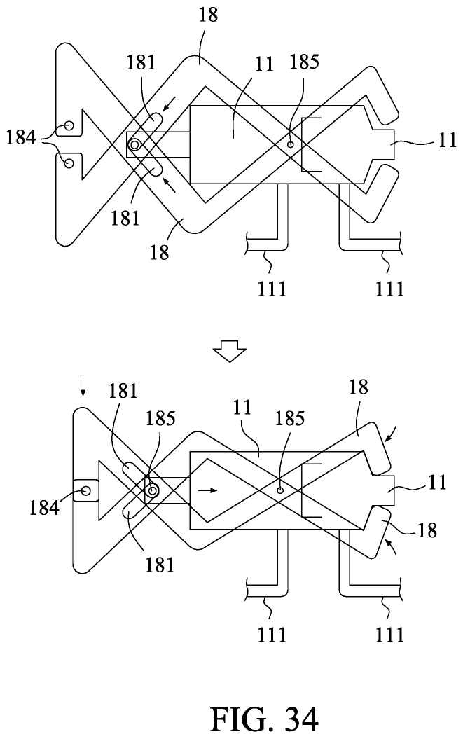

As shown in FIG. 34, in one embodiment of the present disclosure, the differences from the embodiments above are that, the operation portion 18 is a lever structure or a labor-saving structure, so that the operation portion 18 is assembled at the bodies 11 and is linked with or operates the block unit 12. In this embodiment, a combination of two operation portions 18 is a lever structure, each of the operation portions 18 is provided with a coupling portion 184, and the operation portions 18 are joined, combined or fixed by the coupling portions 184 when close to each other during an operation, so as to fix positions of the bodies 11 or the block units 12, thereby enabling the present disclosure to better meet actual application requirements.

In one embodiment of the present disclosure, the differences from the embodiments above are that, when the two operation portions 18 is combined as a lever structure, the operation portions 18 are bolted at one of the bodies 11 and the block unit 12, and the operation portions 18 have a movement space 181 where they interact with each other to implement a lever movement, so that the operation portions 18 operate the block unit 12 and assemble the two bodies 11, thereby enabling the present disclosure to better meet actual application requirements.

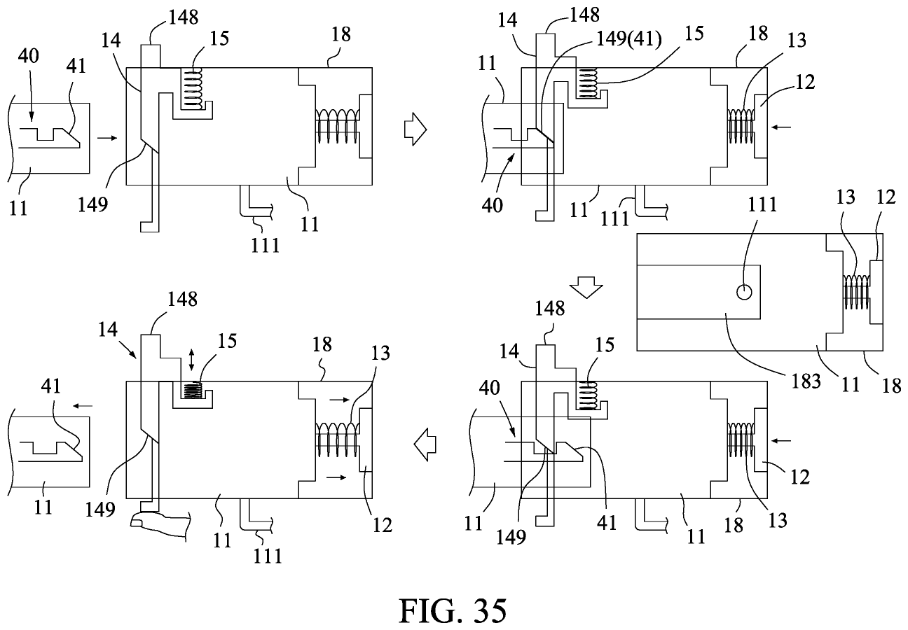

As shown in FIG. 35, in one embodiment of the present disclosure, the differences from the embodiments above are that, the fastener 14 is elastically engaged with an other fastener 40 of the other body 11, the fastener 14 (or the other fastener 40) is provided with an operation portion 148, and the operation portion 148 can be operated to engage the two bodies 11. Moreover, the fastener 14 and the other fastener 40 are respectively provided with guide portions 149 and 41, and the guide portions 149 and 41 can guide the fastener 14 and the other fastener 40 to engage the two bodies 11 and are respectively sloped surfaces, arched surfaces or curved surfaces. The fastener 14 (or the other fastener 40) is provided with a second elastic element 15, which can elastically push to reciprocally open and close the fastener 14 (or the other fastener 40). Thus, the two bodies 11 can be securely engaged with each other by using the fastener 14 and the other fastener 40, or be disengaged from each other by using the fastener 14 and the other fastener 40 to separate the two bodies 11 from each other, thereby enabling the present disclosure to better meet actual application requirements.

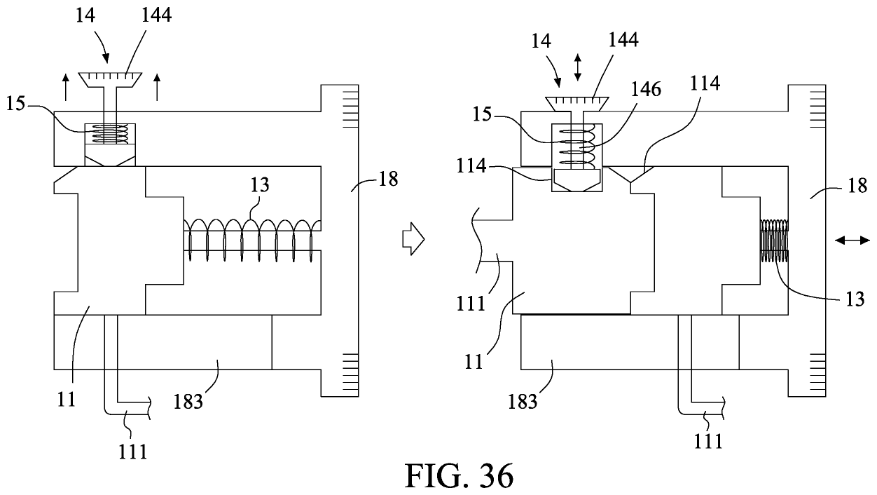

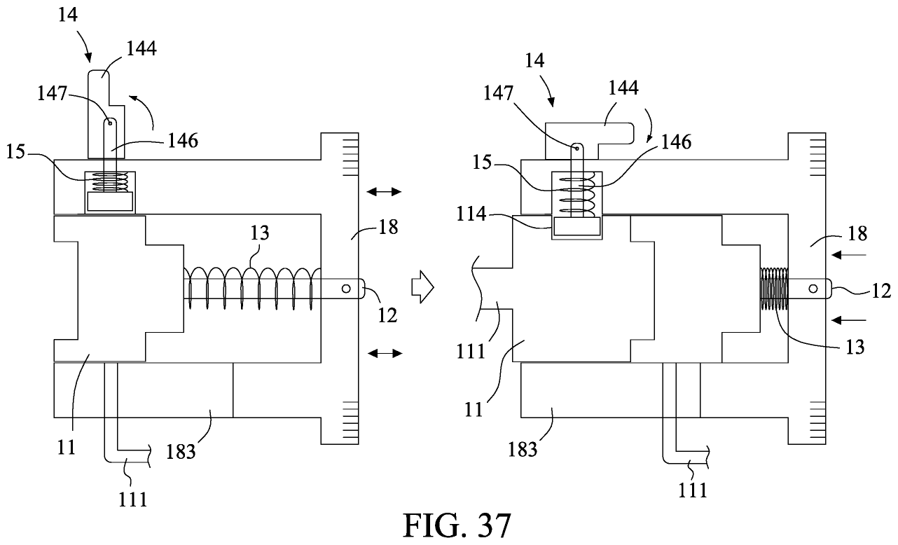

As shown in FIG. 36 and FIG. 37, in one embodiment of the present disclosure, the differences from the embodiments above are that, the block unit 12 and the operation portion 18 are a formed integral (as shown in FIG. 36), or the block unit 12 and the operation portion 8 are assembled with each other (for example, by bolt connection, engagement connection or lock connection, as shown in FIG. 37), the operation portion 18 is provided with at least one fastener 14, the fastener 14 and the operation portion 18 are link engaged at the other body 11, the fastener 14 has an insert portion 146, and the second elastic element 15 pushes between the operation portion 18 and the insert portion 146, so that the insert portion 146 achieves an effect of automatic reset in coordination with the second elastic element 15.

In one embodiment of the present disclosure, the differences from the embodiments above are that, the head 144 of the fastener 14 can be pulled to change an engagement position (as shown in FIG. 36), so that the fastener 14 is linked in coordination with the second elastic element 15 and the operation portion 18 to be engaged at the other body 11, and the operation portion 18 can also be used as the block unit 12, thereby enabling the present disclosure to better meet actual application requirements.

In one embodiment of the present disclosure, the differences from the embodiments above are that, the head 144 of the fastener 14 and the insert portion 146 can be movably combined by a bolt 147 in between to rotate the head 144 to change an engagement position (as shown in FIG. 37), so that the fastener 14 is linked in coordination with the second elastic element 15 and the operation portion 18 to be engaged at the other body 11, thereby enabling the present disclosure to better meet actual application requirements.

In one embodiment of the present disclosure, the differences from the embodiments above are that, the insert portion 146 of the fastener 14 and the other body 11 respectively include guide surfaces145 and 114, and the guide surface 114 can guide the fastener 14 to be engaged at the other body 11, thereby enabling the present disclosure to better meet actual application requirements.

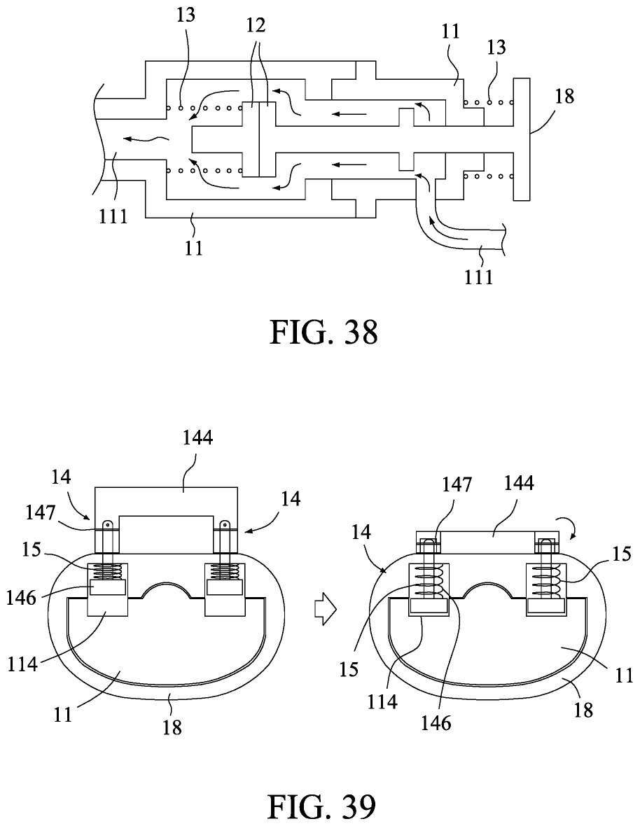

As shown in FIG. 38, in one embodiment of the present disclosure, the differences from the embodiments above are that, a force can be exerted on the operation portion 18 to move a fluid from the block unit 12 of one of the bodies 11 toward the other body 11, and the block unit 12 in the other body 11 is pushed at the same time, so as to open the flow channels 111 and communicate the required channels or to close the flow channels 111, thereby enabling the required fluid to flow stably under guided flow provided by the flow channels 111 of the bodies 11.

As shown in FIG. 39, in one embodiment of the present disclosure, the differences from the embodiments above are that, the fastener 14 is two in number, and the heads 144 of the fasteners 144 can be in form of handles, so that the other body 11 can be linked by the heads 144 of the fasteners 14, thereby enabling the present disclosure to better meet actual application requirements.

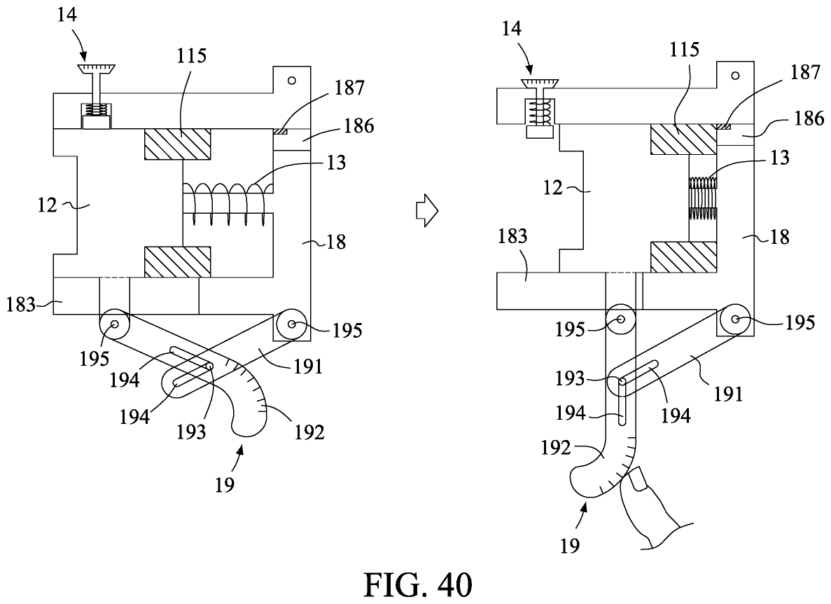

As shown in FIG. 40, in one embodiment of the present disclosure, the differences from the embodiments above are that, the operation portion 18 and one of the bodies 11 are provided with a lever structure 19 in between. The lever structure 19 includes a rotating portion 191 and a lever portion 192, the rotating portion 191 and the lever portion 192 are assembled by a shaft 193 and are linked, the rotating portion 191 and the lever portion 192 include a motion portion 194 for a movement of the shaft 193, and the lever structure 19 is movably disposed at the operation portion 18 and one of the bodies 11 by a mobile bolt 195, so as to move the block unit 12 by the operation portion 18 in coordination with the lever structure 19 in a labor-saving manner, thereby enabling the present disclosure to better meet actual application requirements.

In one embodiment of the present disclosure, the differences from the embodiments above are that, the block unit 12 of the body 11 operates by the operation portion 18 to open or close the flow channel 111, an absorbing unit 115 is provided on the inside of the body 11, and the absorbing unit 115 is configured to absorb a liquid or preparatively absorb a possible liquid, thereby enabling the present disclosure to better meet actual application requirements.

In one embodiment of the present disclosure, the differences from the embodiments above are that, the operation portion 18 (or the body 11) is provided with a check portion 186. The check portion 186 serves as a check for a limitation of a fluid on the inside or outside of the body 11, or a check for the absorbing unit 115, for example, checking whether a leaking liquid is present, checking whether the absorbing unit 115 has absorbed a liquid, or checking whether there is a change in the absorbing unit 115 due to absorbing a liquid (for example, changes such as a color change or a shape change . . . ), thereby enabling the present disclosure to better meet actual application requirements.

In one embodiment of the present disclosure, the differences from the embodiments above are that, a monitor 187, a CCD, a visual system or an artificial intelligence (AI) apparatus is disposed at the check portion 186, around the check portion 186, or a corresponding check position corresponding to the check portion 186, so as to perform checking or to serve as an internal check of the body 11 to detect whether there is a leaking liquid inside the body 11, thereby enabling the present disclosure to better meet actual application requirements.

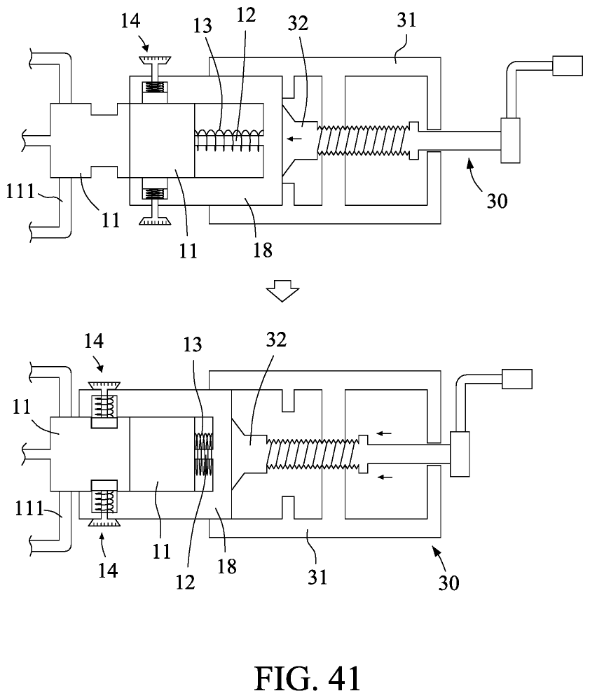

As shown in FIG. 41, in one embodiment of the present disclosure, the differences from the embodiments above are that, the body 11 is two in number, one of the bodies 11 is provided with a tool 30, the tool 30 is combined at the operation portion 18 by a fixing seat 31 and pushes one of the bodies 11 by a force exerting portion 32, so that the tool 30 can drive the block unit 12 to enter the other body 11, and the tool 30 can be a screw, a lever, a labor-saving structure, a gear, a spring structure, a pneumatic structure or a hydraulic structure, thereby enabling the present disclosure to better meet actual application requirements.

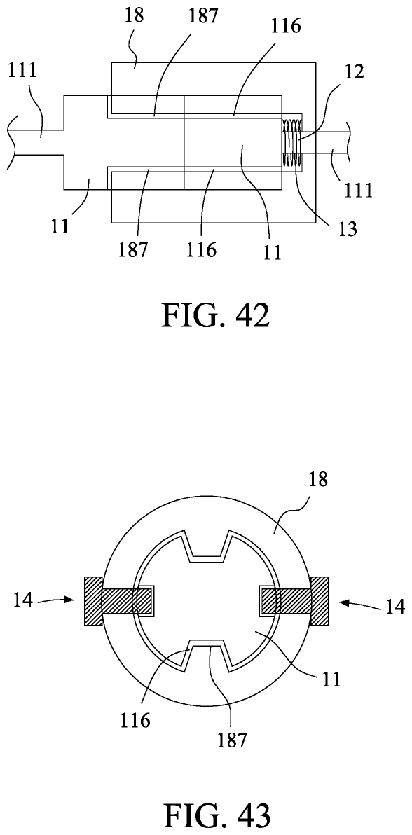

As shown in FIG. 42 and FIG. 43, in one embodiment of the present disclosure, the differences from the embodiments above are that, the body 11 and the operation portion 18 are respectively provided with alignment portions 116 and 187 in between, and the alignment portions 116 and 187 are for alignment between the body 11 and the operation portion 118 to enable the fastener 14 to perform engagement, thereby enabling the present disclosure to better meet actual application requirements.

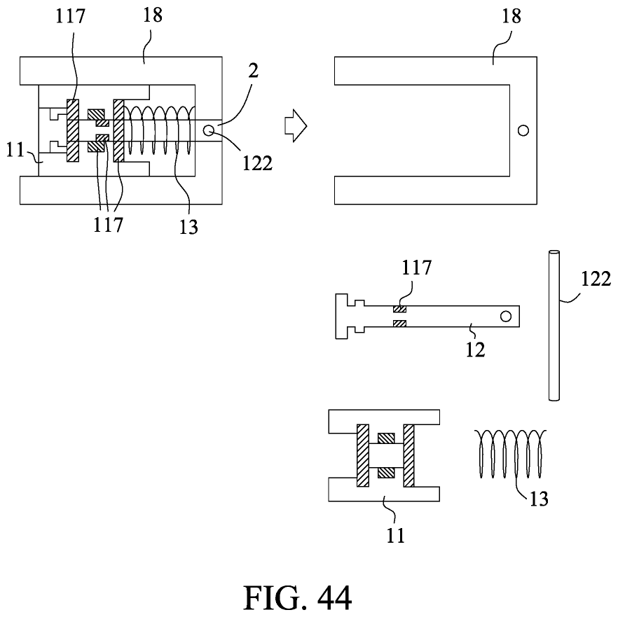

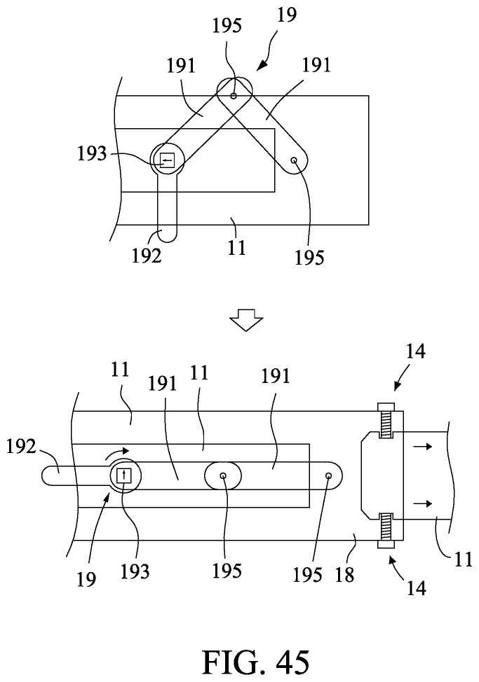

As shown in FIG. 44, in one embodiment of the present disclosure, the differences from the embodiments above are that, the body 11 and the operation portion 18 are provided with a first elastic element 13 in between, and the first elastic element 13 presses a fluid block unit 117 to stop a fluid, thereby enabling the present disclosure to better meet actual application requirements.

In one embodiment of the present disclosure, the differences from the embodiments above are that, the body 11, the block unit 12 and the operation portion 18 are detachably combined with one another, and the block unit 12 and the operation portion 18 are movably assembled by a bolt 122, or the body 11, the block unit 12 and the operation portion 18 are detachably combined with one another to maintain and repair or replace a component of the fluid communicating structure 1, thereby enabling the present disclosure to better meet actual application requirements.

As shown in FIG. 44, in one embodiment of the present disclosure, the differences from the embodiments above are that, a lever structure 19 is further included. The lever structure 19 includes a rotating portion 191 and a lever portion 192. One end of the lever portion 191 is assembled at one of the bodies 11, the other end of the lever portion 191 is assembled at the operation portion 18, and the lever portion 191 is movably disposed at the operation portion 18 and one of the bodies 11 by a mobile bolt 195, so that the lever portion 191 pushes the operation portion 18 to move by rotating the rotating portion 192, or to push the operation portion 18 to engage at the other body 11 to achieve an effect of labor-saving, thereby enabling the present disclosure to better meet actual application requirements.

In one embodiment of the present disclosure, the differences from the embodiments above are that, the rotating portion 192 and the lever portion 191 are assembled and linked by a shaft 193 to achieve an effect of labor-saving, thereby enabling the present disclosure to better meet actual application requirements.

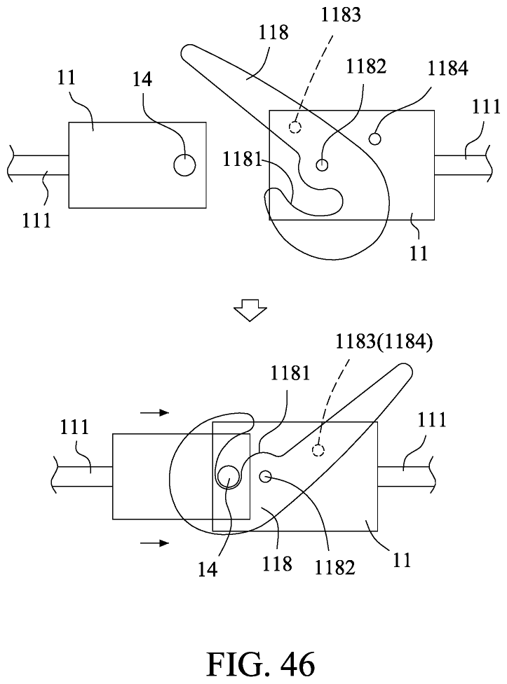

As shown in FIG. 46, in one embodiment of the present disclosure, the differences from the embodiments above are that, the body 11 is two in number, one of the bodies 11 (or one block unit 12 or one operation portion 18) is provided with a motion member 118, the motion member 118 includes a track 1181, and the track 1181 is fitted into the fastener 14 (or fastening portion) of the other body 11 that is pulled close, so as to combine the two bodies and open the flow channel 111.

In one embodiment of the present disclosure, the differences from the embodiments above are that, the motion member 118 is movably disposed at one of the bodies 11 by a shaft 1182, a force can be exerted on the motion member 118 to rotate the motion member 118 in coordination with the shaft 1182, so that the track 1181 is fitted into the fastener 14 of the other body 11 that is pulled close and to accordingly combine the two bodies and open the flow channel 111.

In one embodiment of the present disclosure, the motion member 118 includes a positioning portion 1183, and one of the bodies 11 (or one block unit 12 or one operation portion 18) includes a corresponding positioning portion 1184, so as to fix a position of the motion member 118 by the positioning portion 1183 and the corresponding positioning portion 1184 when the fastener 14 of the other body 11 is pulled close, and to accordingly securely combine the two bodies 11.

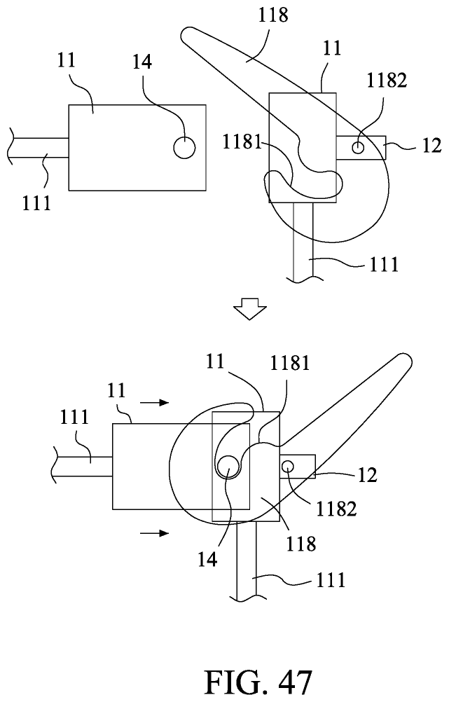

As shown in FIG. 47, in one embodiment of the present disclosure, the differences from the embodiments above are that, the motion member 118 is movably disposed at the block unit 12 by the shaft 1182, and the track 1181 can similarly be fitted into the fastener 14 (or the fastening portion) of the body 11 that is pulled close to combine the two bodies 11 with each other, and the block unit 12 is driven by the motion member 118 for combination so as to open the flow channel 111.

The present invention is described by way of the preferred embodiments above. A person skilled in the art should understand that, these embodiments are merely for describing the present invention and are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A fluid communicating structure, comprising:
at least one body, comprising a flow channel; and
at least one block unit, movably combined with the body, the block unit configured to open or close the flow channel.

2. The fluid communicating structure according to claim 1, wherein the body and the block unit are provided with a first elastic element in between, or the first elastic element locates the block unit to be at an open position of the flow channel, or the first elastic element locates the block unit to be at a closed position of the flow channel, or the body is provided with a body limiting portion, or the block unit coordinates with the body limiting portion and limits at the open position of the flow channel or limits at the closed position of the flow channel.

3. The fluid communicating structure according to claim 1, wherein the block unit is two in number, each of the block units is provided with a first elastic element, and the first elastic elements locate the block units to be at closed positions of the flow channels, or the first elastic elements respectively pressurize the block units to elastically push against each other and be located at the closed positions of the flow channels; or the block unit is two in number, one of the block units is provided with a first elastic element, the first elastic element pressurizes the block units to elastically push against each other and be located at the closed positions of the flow channels, or the first elastic element locates the block unit to be at the closed position of the flow channel; or the block unit or the body is provided with an anti-rotation portion, or the anti-rotation portion prevents rotation of the body or the block unit, or the anti-rotation portion prevents rotation of a fastener, or the anti-rotation portion prevents rotation of an object.

4. The fluid communicating structure according to claim 1, wherein a position at which the flow channel enters the body or a position at which the flow channel is assembled to the block unit is at a different height or a different angle, or the block unit and the flow channel are located at different angles or in different directions, or the block unit and the flow channel form an angle of 90 degrees, or the block unit and the flow channel form an angle between 170 degrees and 10 degrees.

5. The fluid communicating structure according to claim 1, wherein the body or the block unit is provided with a fastener, or the fastener limits the block unit to locate at a position at which the flow channel is open or at a position at which the flow channel is closed; or the block unit is provided with at least one block limiting portion, and the block limiting portion is engaged with a fastener to limit the block unit to locate at a position at which the flow channel is open or at a position at which the flow channel is closed; or the body is provided with at least one limiting portion, and the limiting portion is engaged with a fastener to limit the block unit to locate at a position at which the flow channel is open or at a position at which the flow channel is closed.

6. The fluid communicating structure according to claim 1, wherein the body is two in number, each of the bodies comprises a fastener or a fastening portion, or the bodies are engaged with each other respectively by the fasteners or the fastening portions, or the fastener or fastening portion of one of the bodies is pressed by a second elastic element so as to be engaged with the fastener or the fastening portion of the other body, or the fastener or the fastening portion of one of the bodies comprises a limiting portion, or the fastener or the fastening portion of the other body is engaged at the limiting portion, or each of the fasteners or the fastening portions is a limiting portion, a groove, a recess, a track, a protrusion or a hole, has a neck, has a head, is a column, or is a structure with an inverted hook.

7. The fluid communicating structure according to claim 1, wherein the body is two in number, the flow channels of the bodies are located in different directions, or the flow channels of the bodies are located at different angles, or motion directions of the block unit and the flow channel correspondingly blocked are located in different directions, or motion directions of the block unit and the flow channel correspondingly blocked are located at different angles; or the body is two in number, or the block unit of one of the bodies operates by at least one operation portion; or the body is two in number, or one of the bodies is disposed at an object, or the object is provided with a heat generating unit and a heat dissipating unit, and a fluid in the flow channel flows through the heat dissipating unit to cool the heat generating unit, or the object is a server, a memory, a cabinet, a cooling apparatus, an apparatus, a heat generating unit or a heat dissipating unit.

8. The fluid communicating structure according to claim 1, wherein the body comprises an operation portion, the operation portion is a push unit, a thrust unit, a linking unit, a handle, a labor-saving structure, a lever structure, a track structure, a motion structure, a structure with a movement space, a door, rotating unit, a track, a rod, a column, a bolt, a structure that can assemble two bodies or coordinate with the flow channel and has a reserved portion, or the operation portion is a lever structure or a labor-saving structure, so that the operation portion is assembled at the two bodies and links with or operates the block unit, or the operation portion and one of the bodies are provided with a lever structure in between, or the operation portion is disposed at one of the bodies, or the operation portion is joined or combined at the other body, or the operation portion pushes, connects or is assembled at the block unit, or the operation portion is the block unit, or the operation portion and the block unit are a formed integral, or the block unit is caused to enter the other body so as to open or close the flow channel.

9. The fluid communicating structure according to claim 1, wherein the body comprises an operation portion, the operation portion is disposed at one of the bodies to join or combine the operation portion at the other body, the operation portion pushes the block unit having an elastic force to have the block unit enter the other body so as to open or close the flow channel, and the elastic force of the block unit pushes the operation portion to join or combine the operation portion at the other body.

10. The fluid communicating structure according to claim 1, wherein the body is two in number, each of the bodies comprises an operation portion, the two operation portions are combined as a lever structure, each of the operation portions is provided with a coupling portion, or the operation portions are joined, combine or fixed with each other by the coupling portions so as to fix positions of the bodies or the block unit when close to each other during an operation, or the two operation portions are combined as a lever structure, or the operation portions are respectively bolted at one of the bodies and the block unit, or the operation portions have a movement space where they interact with each other to implement a lever movement so that the operation portions operate the block unit and assemble the two bodies, or a lever structure is further comprised, the lever structure comprises a rotating portion and a lever portion, one end of the lever portion is assembled at one of the bodies, one other end of the lever portion is assembled at the operation portion to have the lever portion push and move the operation portion by rotating the rotating portion, or to push the operation portion to be engaged at the other body, or the rotating portion and the lever portion are assembled and linked by a shaft.

11. The fluid communicating structure according to claim 1, wherein the body or the block unit is provided with a fastener, the fastener is elastically engaged at one other fastener of one other body, or the fastener or the other fastener is provided with an operation portion operable to engage the two bodies, or the fastener or the other fastener is provided with a guide portion, or the guide portion guides to engage the two bodies, and the guide portion is a sloped surface, an arched surface or a curved surface, or the fastener or the other fastener is provided with a second elastic element, or the second elastic element elastically pushes to reciprocally open and close the fastener or the other fastener, or the fastener comprises a head, or the fastener comprises a head rotatable to change an engagement position, or the fastener is two in number, or the fasteners are linked with the other body.

12. The fluid communicating structure according to claim 1, wherein the block unit of the body operates by an operation portion to open or close the flow channel, the body is provided with an absorbing unit, the absorbing unit absorbs a liquid, or the body or the operation portion is provided with a check portion, the check portion serves as a check for a limitation of a fluid on an inside and an outside of the body, or a monitor, a CCD, a visual system or an artificial intelligence (AI) apparatus is disposed at the check portion, around the check portion or a corresponding check position corresponding to the check portion so as to perform checking, or the body is two in number, one of the bodies is provided with a tool, and the tool drives the block unit to enter the other body.

13. The fluid communicating structure according to claim 1, wherein the body or an operation portion is provided with an alignment portion, the alignment portion for alignment to engage a fastener, or the body, the block unit and the operation portion are detachably combined with one another, or the block unit and the operation portion are movably assembled by a bolt, or the body, the block unit and the operation portion are detachably combined with one another to maintain and repair or replace a component of the fluid communicating structure.

14. The fluid communicating structure according to claim 1, wherein the body is two in number, one body, one block unit or one operation portions is provided with a motion member, the body is two in number, one body, one block unit or one operation portion provided with a motion member, the motion member comprises a track which is fitted into a fastener or a fastening portion of the other body that is pulled close, so that the two bodies open the flow channel, or the motion member is movably disposed at one body, one block unit or one operation portion by a shaft, or the motion member comprises a positioning portion, and one body, one block unit or one operation portion comprises a corresponding positioning portion, so as to fix a position of the motion member by the positioning portion and the corresponding positioning portion when the fastener or the fastening portion of the other body is pulled close, or the two bodies are engaged by the fastener and then one block unit or two block units are opened to open the flow channels and communicate a fluid, or the body and the object are engaged by the fastener and then one block unit or two block units are opened to open the flow channels and communicate a fluid.

15. The fluid communicating structure according to claim 1, wherein comprising two block units and two bodies, wherein a force is exerted on one of the block units to push the other block unit so as to open two flow channels, and the block unit enters the other body.
